(19) United States
(12) Patent Application Publication
(10) Pub. No.: US 2026/0148603 A1
(43) Pub. Date: May 28, 2026

(54) CURRENCY TRANSPORT ASSEMBLY FOR NOTE SHINGLING AND METHOD

(71) Applicant: Diebold Nixdorf, Incorporated, North Canton, OH (US)

(72) Inventors: William Beskitt, Canton, OH (US); Michael Harty, Canton, OH (US)

(21) Appl. No.: 19/369,832

(22) Filed: Oct. 27, 2025

Related U.S. Application Data
(60) Provisional application No. 63/712,711, filed on Oct. 28, 2024.
(60) Provisional application No. 63/712,710, filed on Oct. 28, 2024.
(60) Provisional application No. 63/712,707, filed on Oct. 28, 2024.

(51) Int. Cl. G07D 11/16; B65H 5/02; G07D 11/12

(52) U.S. Cl. CPC G07D 11/16; B65H 5/021; G07D 11/12; B65H 2701/1912; G07D 2211/00

(57) ABSTRACT

A method of transporting currency notes can include moving a stack of currency notes into engagement with a belt. The method can also include removing at least a first note and a second note from the stack in a shingled arrangement. The method can also include directing the at least first and second notes into a currency cassette while maintaining the shingled arrangement. A currency transport assembly configured to execute the method and an automated transaction machine in which the currency transport assembly can operate is also disclosed.

### CROSS-REFERENCE TO RELATED APPLICATIONS

This application claims the priority benefit of U.S. Provisional Patent Application Ser. No. 63/712,711 for a CURRENCY TRANSPORT ASSEMBLY FOR NOTE SHINGLING AND METHOD filed on Oct. 28, 2024, of U.S. Provisional Patent Application Ser. No. 63/712,710 for a CURRENCY TRANSPORT ASSEMBLY HAVING MOTOR AND METHOD filed on Oct. 28, 2024, and of U.S. Provisional Patent Application Ser. No. 63/712,707 for a CURRENCY TRANSPORT ASSEMBLY HAVING CAM AND METHOD filed on Oct. 28, 2024, which are all hereby incorporated by reference in their entireties.

### BACKGROUND

### 1. Field

The present disclosure relates to systems and mechanisms for the handling of sheets such as currency notes.

### 2. Description of Related Prior Art

An automated transaction machine (ATM) is an electronic telecommunications and computing device that enables account holders of a financial institution to perform transactions, such as cash withdrawal, check deposit and account balance inquiries, without the need for a human bank teller. The ATM includes a processor and memory. The processor executes an operating system during operation. It has been estimated that there are over three million ATMs installed throughout the world. During a transaction, by way of example, the account holder identifies himself/herself by first inserting a plastic card into the ATM of a financial institution. The card contains a magnetic stripe or a chip that contains account-identification information. Secondary or “personal” authentication information is then provided by the account holder by entering a personal identification number (PIN) which must match the PIN stored in the financial institution's database.

Occasionally, a note of currency that is within an ATM is found by one or more sub-systems of the ATM to be deficient for some reason. For example, the note may not be verifiable by a scanner checking for counterfeit notes. In another example, a note may become jammed within the ATM and thus become crumpled or folded. Such notes are at least sometimes referred to in the art as “reject” notes and are at least sometimes directed to a “reject” cassette or storage. Occasionally, one or more notes of currency are presented by the ATM to a user who has requested the currency, but the notes are not taken by the user for some reason. Such notes are taken back by the ATM and are at least sometimes referred to in the art as “retract” notes.

The background description provided herein is for the purpose of generally presenting background context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A method of transporting currency notes can include moving a stack of currency notes into engagement with a belt. The method can also include removing at least a first note and a second note from the stack in a shingled arrangement. The method can also include directing the at least first and second notes into a currency cassette while maintaining the shingled arrangement.

According to other features, the method can also include directing a second stack of currency notes into the currency cassette individually and not in a shingled arrangement. The moving step can include bringing first and second plates together on opposite sides of the stack of currency notes and positioning a flat portion of a surface area of the belt in a plane between the first and second plates. The removing can include engaging the flat portion of the surface area of the belt directly with a first currency note of the stack of currency notes and rotating the belt.

In other features, the method can also include pressing a portion of a first side of the stack of currency notes against the flat portion of the surface area of the belt during the removing. The method can also include leaving exposed a remainder of the first side of the stack of currency notes other than the portion between the first and second plates.

A currency transport assembly can include a shuttle having a first plate defining a first surface and a second plate defining a second surface that confronts the first surface. The second plate can also include a notch. The shuttle can be moveable and a first plurality of currency notes can be positioned in a stacked arrangement between the first plate and the second plate. The currency transport assembly can also include a belt having a surface area including a flat portion that confronts the first surface and is at least partially positioned in the notch.

According to additional features, the flat portion of the surface area of the belt can be positioned in a plane between the first plate and the second plate. The plane can be further defined as closer to the first plate than the second plate. The currency transport assembly can also include a first wheel configured to rotate about a first axis of rotation and a second wheel configured to rotate about a second axis of rotation. The second axis of rotation can be parallel to the first axis of rotation. The flat portion of the surface area of the belt can extend between the first wheel and the second wheel. The first wheel and the second wheel can extend at least partially through the notch.

According to other features, the currency transport assembly can also include a currency cassette. A transport path of the currency notes of the first plurality of currency notes can define at least from a space between the first plate and the second plate to the currency cassette. The shuttle and the belt can be configured such that the first plurality of currency notes is altered from the stacked arrangement to a shingled arrangement and is directed into the currency cassette in the shingled arrangement. The currency cassette can include a partition dividing an interior of the currency cassette into a first volume and a second volume. The first plurality of currency notes can be directed into only one of the first volume and the second volume. The first volume can be smaller than the second volume. The first plurality of currency notes can be directed into only the first volume. The currency cassette can also include a gate mounted on the partition for pivoting movement between a first position blocking the first volume and a second position blocking the second volume. The currency transport assembly can also include a second gate positioned along the path between the belt and the gate.

An automated transaction machine can include a first currency cassette, a second currency cassette, a currency transport assembly, and a first gate. The first currency cassette can be configured to hold a first plurality of currency notes. The second currency cassette can be spaced from the first currency cassette and can be configured to separately hold reject notes and retract notes. The currency transport assembly can have a shuttle with a first plate defining a first surface and a second plate defining a second surface that confronts the first surface. The second plate can also include a notch. The shuttle can be moveable and a second plurality of currency notes can be positioned in a stacked arrangement between the first plate and the second plate. The currency transport assembly can also have a belt having a surface area including a flat portion that confronts the first surface and is at least partially positioned in the notch. The belt can be configured to rotate and direct notes of the second plurality of currency notes out of the shuttle. The first gate can be positioned adjacent to the belt and moveable between at least a first position directing the notes of the second plurality of currency notes that are directed out of the shuttle to the first currency cassette and a second position directing the notes of the second plurality of currency notes that are directed out of the shuttle to the second currency cassette. In one or more embodiments of the present disclosure, notes submitted for deposit can be directed from the shuttle back into a cassette that is positioned in a rack. The shuttle and the belt can be configured such that the second plurality of currency notes is altered from the stacked arrangement to a shingled arrangement when the second plurality of currency notes are directed out of the shuttle to the second currency cassette.

In other features, the automated transaction machine can also include a second gate positioned within the second currency cassette for pivoting movement between a first position blocking a first volume within the second currency cassette and a second position blocking a second volume within the second currency cassette. The first gate can be positioned between the second gate and the belt along a transport path of the notes of the second plurality of currency notes. The first volume can be smaller than the second volume.

### BRIEF DESCRIPTION OF THE DRAWINGS

The detailed description set forth below references the following drawings:

FIG. 1 is a functional block diagram of an exemplary ATM according to one or more implementations of the present disclosure;

FIG. 2 is a functional block diagram of an exemplary financial transaction computing system according to one or more implementations of the present disclosure;

FIG. 3 is a perspective view of a second exemplary embodiment of the present disclosure taken from rear, left, and top sides;

FIG. 4 is a cross-section of the second exemplary embodiment taken through section lines 4-4 in FIG. 3;

FIG. 4A is a magnified portion of FIG. 4;

FIG. 5 is a first magnified portion of the structure shown in FIG. 4 but with some components in a different positions or orientations;

FIG. 6 is a second magnified portion of the structure shown in FIG. 4 but with some components in a different positions or orientations;

FIG. 7 is a perspective view of the second exemplary embodiment directed at the components utilized in arranging notes in a shingle pattern;

FIG. 8 is similar to FIG. 5 but shows currency notes being moved into a shuttle of the second exemplary embodiment;

FIG. 9 is also similar to FIG. 5 but shows currency notes being moved into a reject portion of a cassette of the present disclosure;

FIG. 10 is similar to FIG. 6 but shows currency notes being moved from the shuttle and being arranged into a shingle pattern and directed into a retract portion of the cassette;

FIG. 11 is a magnified portion of FIG. 10 with some structures removed to clarify the area in which currency notes are stored and move;

FIG. 12 is a second perspective view of the second exemplary embodiment of the present disclosure taken from rear, right, and top sides;

FIG. 13 is a third perspective view of the second exemplary embodiment of the present disclosure taken from front, right, and top sides;

FIG. 14 is a fourth perspective view of the second exemplary embodiment of the present disclosure taken from front, left, and top sides;

FIG. 15 is a top view of a shuttle assembly portion of the second exemplary embodiment of the present disclosure;

FIG. 16 is a front view of the shuttle assembly portion of the second exemplary embodiment of the present disclosure;

FIG. 17 is a right side view of the shuttle assembly portion of the second exemplary embodiment of the present disclosure;

FIG. 18 is a perspective and sectional view, taken from the right, front and top with the sectional plane defined by section line 18 in FIG. 15;

FIG. 19 is a perspective and sectional view, taken from the right, front and top with the sectional plane defined by section line 19 in FIG. 15;

FIG. 20 is a perspective and sectional view, taken from the right, front and top with the sectional plane defined by section line 20 in FIG. 15;

FIG. 21 is a planar sectional view taken in the sectional plane defined by section line 20 in FIG. 15;

FIG. 21A is a planar sectional view similar to FIG. 21 but of an alternative embodiment of the present disclosure;

FIG. 22 is a perspective and sectional view, taken from the right, front and top with the sectional plane defined by section line 22 in FIG. 15;

FIG. 23 is a perspective and sectional view, taken from the right, front and bottom with the sectional plane defined by section line 23 in FIG. 15;

FIG. 24 is a perspective and sectional view, taken from the right, front and bottom with the sectional plane defined by section line 24 in FIG. 15;

FIG. 24A is a perspective and sectional view similar to FIG. 24 but of an alternative embodiment of the present disclosure;

FIG. 25 is a perspective and sectional view, taken from the right, front and bottom with the sectional plane defined by section line 25 in FIG. 15 and with some components removed to enhance the visibility of the components that are shown and FIG. 25A is similar to FIG. 25 but of an alternative embodiment;

FIG. 26 is a perspective and sectional view, taken from the right, front and top with the sectional plane defined by section line 26 in FIG. 15;

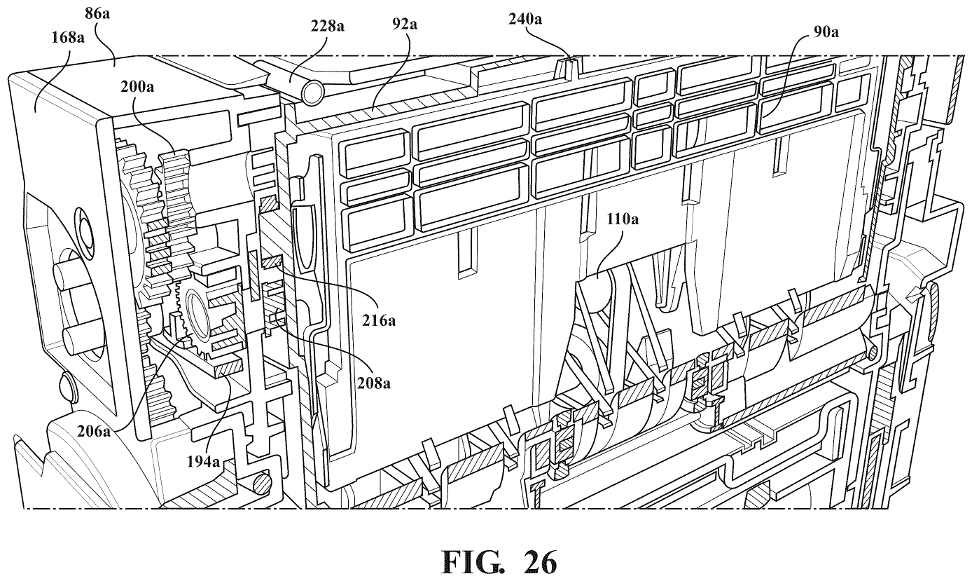

FIG. 27 is a perspective and sectional view, taken from the right, front and top with the sectional plane defined by section line 27 in FIG. 15;

FIG. 28 is a perspective view of the shuttle assembly portion of the second exemplary embodiment of the present disclosure with some components omitted, some components in phantom, and a shuttle of the shuttle assembly at a distal end to receive or present currency notes;

FIGS. 29A-C are sequential side images during movement of the shuttle of the shuttle assembly between a vertical orientation and a horizontal orientation;

FIG. 30 is an exploded view of gears of the second exemplary embodiment of the present disclosure;

FIG. 30A is an exploded view similar to FIG. 30 but of an alternative embodiment of the present disclosure;

FIG. 31 is a perspective and partial view taken from the right, front and top of the second exemplary embodiment of the present disclosure;

FIG. 32 is a portion of a cross section taken through section line 32 in FIG. 31 (through a plane in the middle of the front-to-back depth of the second exemplary embodiment);

FIG. 33 is a perspective view of a latch of the second exemplary embodiment taken from the front and bottom;

FIG. 34 is a first perspective view of a cam of the second exemplary embodiment;

FIG. 35 is a second perspective view of the cam of the second exemplary embodiment;

FIG. 36 is a third perspective view of the cam of the second exemplary embodiment;

FIG. 37 is a fourth perspective view of the cam of the second exemplary embodiment;

FIG. 38 is a perspective view of various components of the second exemplary embodiment;

FIG. 39 is a view of the components shown in FIG. 38 from a different perspective;

FIG. 40 is a perspective view of a lock of the second exemplary embodiment;

FIG. 41 is a perspective view of various components of the second exemplary embodiment;

FIG. 42 is a perspective view of various components of the second exemplary embodiment;

FIG. 43 is a perspective view of various components of the second exemplary embodiment;

FIG. 44 is a perspective view of various components of the second exemplary embodiment taken from the right, back and top of the second exemplary embodiment of the present disclosure;

FIG. 45 is an exploded view of a cam plate and a lever arm of the second exemplary embodiment;

FIG. 46 is a perspective view of a gate of the second exemplary embodiment;

FIG. 47 is a perspective view of various components of the second exemplary embodiment;

FIG. 48 is similar to FIG. 47 but shows a cross sectional plane taken through some of the components;

FIG. 49 is an exploded view of various components of the second exemplary embodiment; and

FIG. 50 is a substantially orthogonal (non-perspective) front view of the cam shown in FIGS. 34-37; and

FIG. 51 is a substantially orthogonal (non-perspective) rear view of the cam shown in FIGS. 34-37 and 50.

### DETAILED DESCRIPTION

The present disclosure, as demonstrated by the exemplary embodiment described below, can provide a system for handling notes of currency. Embodiments of the present disclosure can be applied in other operating environments, to move sheets that are not currency notes. The exemplary embodiment described below is applied to retract notes/sheets, reject notes/sheets, received notes/sheets, and dispensed notes/sheets, but other embodiments of the present disclosure can be applied to notes that are not retract notes and to sheets other than currency.

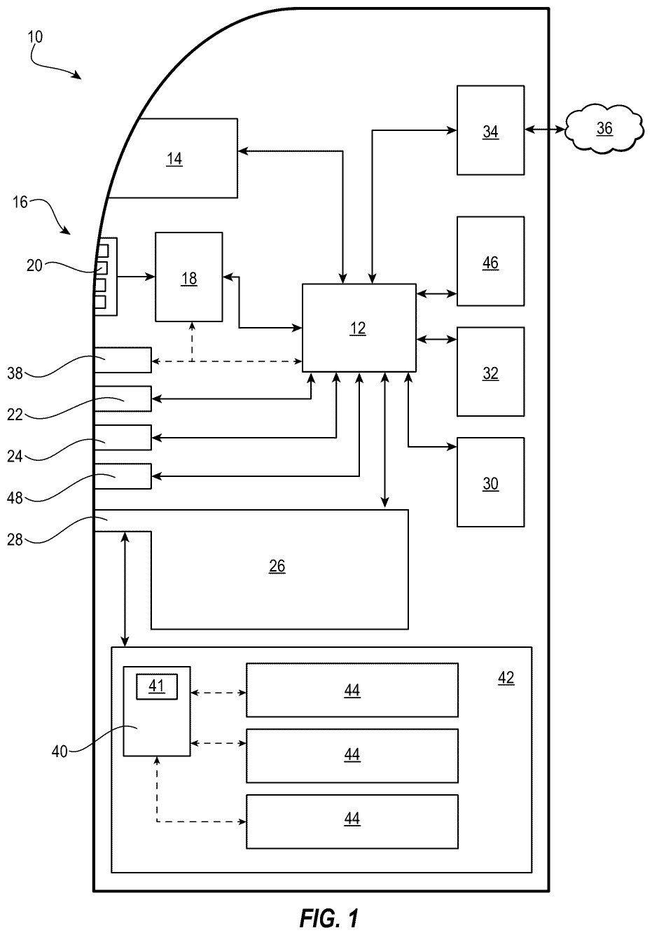

Referring now to the drawings, FIG. 1 discloses a functional block diagram of an exemplary ATM 10 according to one or more implementations of the present disclosure. The ATM 10 includes different structures and subsystems for receiving input from a user and executing transactions. The ATM 10 includes a computing device 12. The exemplary computing device 12 has one or more processors and a non-transitory, computer readable medium. The computing device 12 operates under the control of an operating system, kernel and/or firmware and executes or otherwise relies upon various computer software applications, components, programs, objects, modules, data structures, etc. The exemplary computing device 12 can operate under the control of the Windows® operating system. The computer readable medium (memory) of the computing device 12 can include random access memory (RAM) devices comprising the main storage of computing device 12, as well as any supplemental levels of memory, e.g., cache memories, non-volatile or backup memories (e.g., programmable or flash memories), read-only memories, etc. In addition, the memory may be considered to include memory storage physically located elsewhere from RAM in the computing device 12, such as any cache memory in a processor, as well as any storage capacity used as a virtual memory. The computing device 12 can also include one or more mass storage devices, e.g., a floppy or other removable disk drive, a hard disk drive, a direct access storage device (DASD), an optical drive (e.g., a CD drive, a DVD drive, etc.), and/or a tape drive, among others, represented by memory 46.

The exemplary ATM 10 also includes a display 14. The computing device 12 can control the display 14 to present information to the user for furthering completion of the transaction. The display 14 can be a touch screen that allows the user to enter information through the display 14. The exemplary display 14 is configured to transmit any user-entered information to the computing device 12.

The exemplary ATM 10 also includes a keypad 16 and an encryption module 18. Generally, the combination of a keypad and an encryption module are referred to in the art as an encrypted pin pad (EPP). The exemplary keypad 16 includes a plurality of keys, such as key 20. The exemplary encryption module 18 has one or more processors and a non-transitory, computer readable medium. The user can press the keys of the keypad 16 to enter a Personal Identification Number (PIN) or other numerical data. It is noted that the user may also enter a PIN through the display 14. The keypad 16 is placed in communication with the encryption module 18 and therefore the numbers of the PIN are received by the encryption module 18. Any numbers entered through the display 14 can also be received by the encryption module 18. It is noted that the communication of the PIN is direct and secure; the PIN cannot be intercepted between the keypad 16 and the encryption module 18. The PIN is then encrypted by the encryption module 18 to define a PIN block. The encryption module 18 includes a network encryption key and applies the network encryption key to encrypt the PIN to the PIN block. The exemplary encryption module 18 is configured to transmit the PIN block to the computing device 12, which can direct the PIN block away from the ATM 10 during the completion of a financial transaction.

The exemplary ATM 10 also includes a card reader 22. The card reader 22 can receive a token from the user, such as a card. The card reader 22 can be configured to execute read and write operations with respect to any storage medium fixed to the user's card. The exemplary card reader 22 can be configured to read data from a magnetic strip on the back of a card or a chip embedded in the card. The exemplary card reader 22 can be configured to transmit any data read from the user's card to the computing device 12, which can direct the data read from the card away from the ATM 10 during completion of a financial transaction. The exemplary card reader 22 can also be configured to receive commands and data from the computing device 12 and change data stored on the user's card.

The exemplary ATM 10 also includes a printer module 24. The computing device 12 can control the printer module 24 to print a receipt when a transaction has been completed. The printer module 24 can communicate one or more messages to the computing device 12, such as a maintenance message regarding the need to refill printer paper.

The exemplary ATM 10 also includes an article exchange unit 26. In the exemplary embodiment, the article exchange unit 26 is configured to receive items such as checks. It is noted that an article exchange unit taking the form of a check module is optional in embodiments of the present disclosure. An exemplary article exchange unit 26 can include a drum on which received items are stored. The exemplary article exchange unit 26 includes a slot 28 open to an exterior of the ATM 10 for the receipt of such items. In other embodiments of the present disclosure, an article exchange unit can be configured to facilitate the receipt of other items, different than paper. The article exchange unit 26 can include one or more sensors and transmit signals from any such sensors to the computing device 12 to execute an exchange. The computing device 12 can control the article exchange unit 26 in response to such signals. For example, the article exchange unit 26 can include a sensor that detects receipt of an item such as a check. The article exchange unit 26 can include a further sensor in the form of a scanner that generates an image of the received item and transmits the image to the computing device 12. When an exchange involves the dispensation of an article to the user, the computing device 12 can control the article exchange unit 26 to dispense the item(s) requested by the user.

The exemplary ATM 10 also includes a printer module 30. The printer module 30 can generate a continuous record of all transactions executed by the ATM 10. The computing device 12 can control the printer module 30 to supplement the record after each transaction has been completed. The printer module 30 can communicate one or more messages to the computing device 12, such as a maintenance message regarding the need to refill printer paper.

The exemplary ATM 10 also includes an access module 32. The access module 32 can be positioned proximate to a rear side of the ATM 10 and spaced from a front side of the ATM 10. The access module 32 can be utilized by service and support technicians. For example, the access module 32 can be utilized by a field engineer to complete software updates to the computing device 12. The access module 32 can also be utilized when non-software updates and maintenance is performed, such as the refilling of printer paper or currency.

The exemplary ATM 10 also includes a first transceiver 34. The exemplary first transceiver 34 is configured to facilitate communication between the computing device 12 and other computing devices that are distinct from and physically remote from the computing device 12. An example of such a remote computing device is a server computing device, such as a banking or financial institution server communicating with a plurality of ATMs or a switch of the financial network. The exemplary first transceiver 34 places the computing device 12 in communication with one or more networks, such as network 36.

The network 36 can be a local area network (LAN); a wide area network (WAN) such as the Internet; a Multi-protocol label switching (MPLS) network; a cellular network such as operated by cellular phone companies; a secure financial/bank communications network such as NYCE, PULSE, PLUS, Cirrus, AFFN, Interac, Interswitch, STAR, LINK, MegaLink, or BancNet; or any combination thereof. The first transceiver 34 can transmit data and requests for input generated by the computing device 12 over the network 36 and receive responses to these requests over the network 36, directing these responses to the computing device 12.

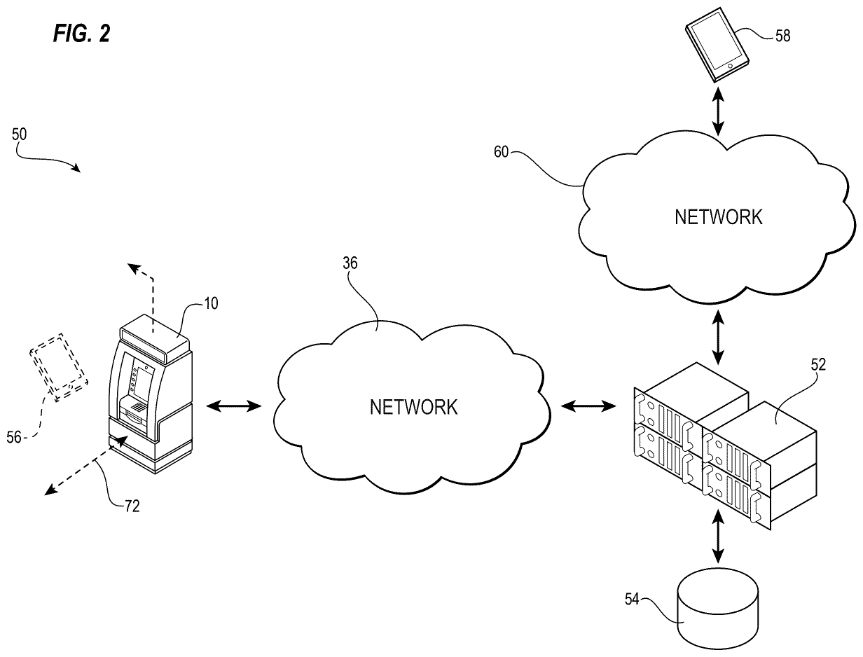

The exemplary ATM 10 also includes a second transceiver 38. The exemplary second transceiver 38 is configured to facilitate communication between at least one of the encryption module 18 and the computing device 12 and other computing devices that are distinct from and physically proximate to the ATM 10. An example of such a proximate computing device is a smartphone (a mobile computing device) possessed by the user, referenced at 56 in FIG. 2. The dashed connection lines in FIG. 1 represent optional interconnections. The exemplary second transceiver 38 can place the user's smartphone in communication with the encryption module 18, the computing device 12, or both. The exemplary second transceiver 38 can implement various communication protocols. For example, the second transceiver 38 can be a Near Field Communication (NFC) device. Alternatively, the second transceiver 38 can be a Bluetooth beacon. The second transceiver 38 can transmit and receive data and requests for input generated by the encryption module 18 and/or the computing device 12, such transmissions occurring with the user's smart phone for example.

The exemplary ATM 10 also includes a currency transport assembly 40. The currency transport assembly 40 can dispense banknotes, such as currency. The currency transport assembly 40 can include gears, shafts, belts, rollers, plates, motors, and other structures commonly applied in currency dispensers. The exemplary currency transport assembly 40 is shown positioned primarily in a safe 42, but a currency dispenser applied in one or more embodiments of the present disclosure can include components positioned in the safe 42 and other components positioned in an upper portion or head of the ATM 10 outside of the safe 42. A double-arrow line is shown in FIG. 1 to represent the movement of currency between the safe 44 and the slot 28 and also schematically represent components of the currency transport assembly 40 positioned outside of the safe 42.

One or more cassettes or cash boxes 44 are also positioned and protected in the safe 42. Banknotes are stored in the cassettes 44 for disbursement to a user of the ATM 10. Banknotes received from the customer can be stored in one or more of the cassettes. The exemplary currency transport assembly 40 can extract the banknotes from one or more of the cassettes 44 and direct them out of the ATM 10 through the slot 28. The exemplary currency transport assembly 40 thus communicates with the slot 28 in parallel with the exemplary article exchange unit 26. It is noted that, in one or more embodiments of the present disclosure, more than one slot may be provided, such as a first slot dedicated for currency and a second slot dedicated for checks if a check module is included. The exemplary currency transport assembly 40 can communicate with and be controlled by the computing device 12 for at least some operations. Each of the cassettes 44 can engage the currency transport assembly 40 through a rack whereby the positioning of the cassettes is controlled. Further, each of the cassettes 44 and the currency transport assembly 40 can include mating connectors of any form, whereby a positive interconnection is confirmed electronically. When one or more of the cassettes 44 and the currency transport assembly 40 are not properly interconnected, a signal or lack thereof can be communicated to the computing device 12 whereby an error message is generated or the ATM 10 can be disabled. One or more of the cassettes can be dedicated to holding currency that can be dispensed to a user (an “operating” cassette), to retaining notes that are deficient (a “reject” cassette), or to retaining notes that were presented to the user but not taken (a retract cassette).

The exemplary currency transport assembly 40 can also be configured to intake currency notes through the slot 28 from a user/depositor and direct such notes to one or more of the cassettes 44. FIG. 1 schematically shows the exemplary currency transport assembly 40 includes an exemplary validator 41 that validates and classifies different note denominations received by the exemplary currency transport assembly 40. It is also noted that one of the cassettes can be utilized to hold reject notes and thus be a “reject” cassette.

The exemplary ATM 10 also includes a scanner 48. The scanner 48 can scan, for example, at least a portion of a display of a smart phone and communicate the scanned display to the computing device 12. A token can be displayed on the display of the smart phone and thus scanned by the scanner 48. The token can be a bar code, a quick response (QR) code, a number, a string of alphanumeric characters, a weblink, or some other symbolic indicia or biometric data. The exemplary scanner 48 is configured to transmit any scanned data to the computing device 12, which can direct the scanned data away from the ATM 10 during completion of a financial transaction.

FIG. 2 is a functional block diagram of an exemplary system 50 according to one or more implementations of the present disclosure. The exemplary system 50 includes the ATM 10. The exemplary system 10 also includes a computing device 52, which is a server computing device in the exemplary embodiment of the present disclosure. The computing device 52 can be a banking core and can access a database 54 of accounts maintained by a financial institution. The exemplary computing device 52 has one or more processors and a non-transitory, computer readable medium. The exemplary system 50 can be operated by a financial institution, a “bank core,” and the user can be an account holder of the financial institution. Other implementations of the present disclosure, by way of example and not limitation, can be a system operated by a merchant of consumer goods, a provider of healthcare-related products, or a delivery company.

The ATM 10 and the computing device 52 can communicate over the network 36. Transmissions over the network 36 may be encrypted and may include Message Authentication Codes (MACs) to enhance security. MACs can be appended to messages sent from and received by a device such as the ATM 10. MACs verify that the messages sent and the messages received are identical and also confirm that messages originate from an approved source. The computing devices 12 and 52 can also apply Transport Layer Security (TLS) or Secure Sockets Layer (SSL) protocols and include respective firewalls to enhance security. The computing device 52 can also communicate with user computing devices, such as a user's tablet computer 58, over a network 60. The network 60 can be a local area network (LAN), a wide area network (WAN) such as the Internet, a Multi-protocol label switching (MPLS) network, a cellular network such as operated by cellular phone companies, a financial network, or any combination thereof.

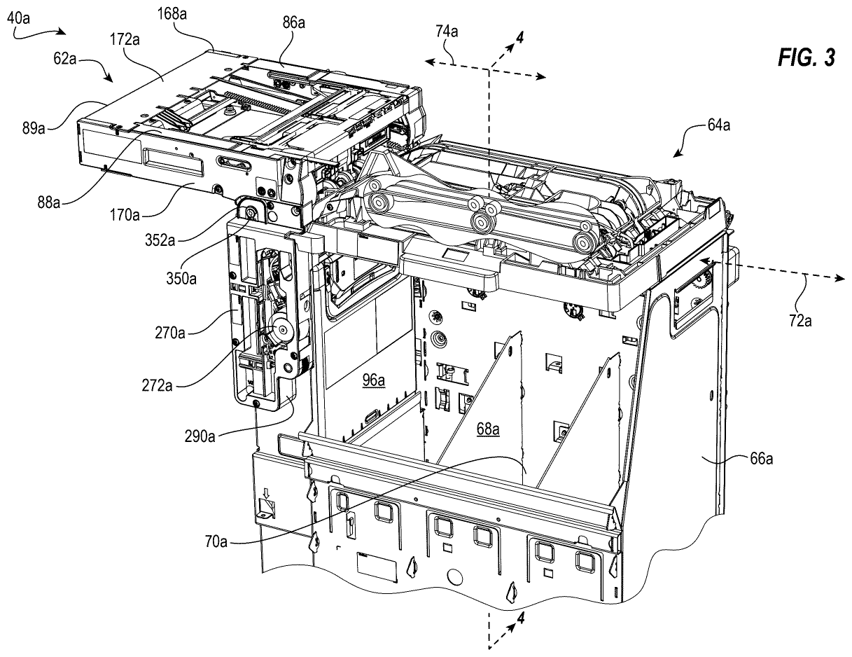

Referring now to FIG. 3, a second embodiment of an exemplary currency transport assembly 40a includes a shuttle assembly 62a and a note transport 64a. FIG. 3 also shows a rack 66a. The exemplary rack 66a includes internal walls such as internal wall 68a that define bays such as bay 70a. Although not shown in FIG. 3, a currency cassette can be received in each bay. The rack 66a can be mounted on rolling tracks in a safe such as safe 42 so the rack 66a and associated cassettes can be easily drawn out of the safe and further so that cassettes can be replaced.

The shuttle assembly 62a and the note transport 64a can be positioned inside or outside of the safe. If positioned outside of the safe, the exemplary shuttle assembly 62a and the exemplary note transport 64a would be within a fascia and/or outer housing of the ATM. It is noted that a front-to-back axis, generally centered on the width of the ATM is referenced at 72a. A similar axis 72 is shown in FIG. 2. Referring again to FIG. 3, an axis parallel to, coplanar with, and spaced from axis 72a is referenced at 74a. Section lines 4-4 are perpendicular to the plane containing the axes 72a, 74a.

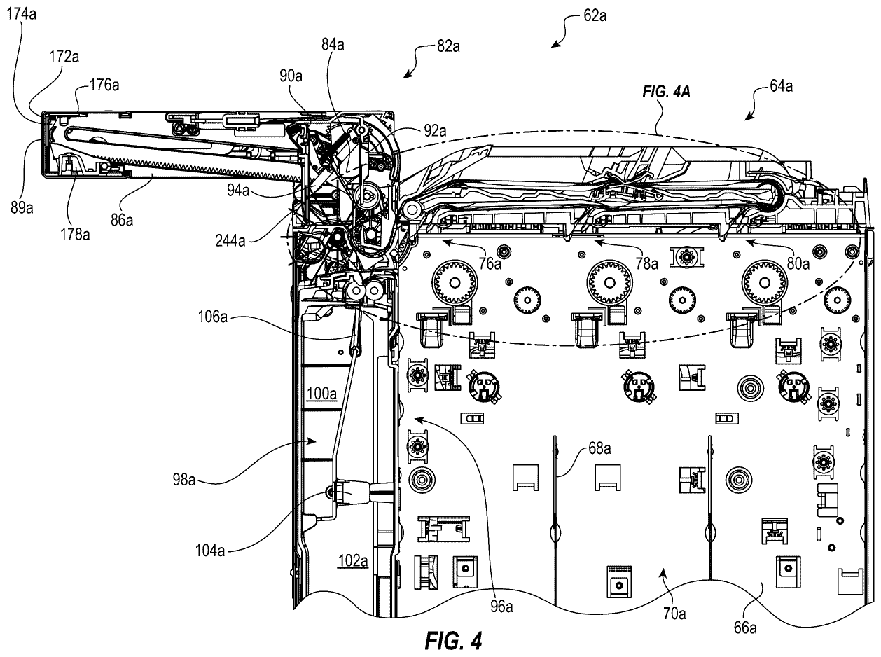

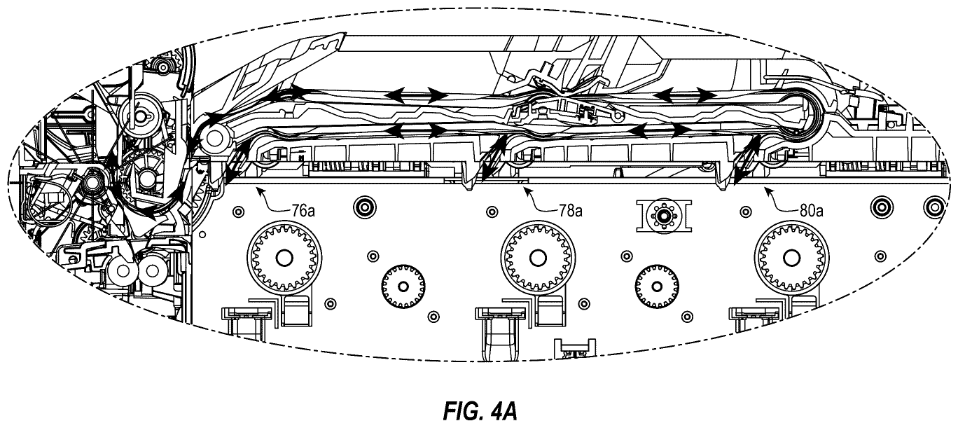

Referring now to FIGS. 4 and 4A, the note transport 64a includes a plurality of ports 76a, 78a, 80a through which currency notes pass between the note transport 64a and currency cassettes in the rack 66a. The note transport 64a defines a transport path for currency notes. The path is marked in FIG. 4 with double arrows in solid line. The use of double arrows connotes movement along the path in both directions. The note transport 64a can include wheels, belts, rollers, and other structures that engage currency notes and move currency notes along the transport path. Currency notes drawn from the currency cassettes can be collected in a shuttle 82a of the exemplary shuttle assembly 62a. The location within the shuttle 82a where the currency notes are collected is referenced at 84a.

Referring now to FIGS. 3 and 4, the exemplary shuttle assembly 62a includes first and second side plates 86a, 88a that each define a track along which the shuttle 82a moves. The side plates 86a, 88a extend between respective base ends and distal ends, referenced at cumulatively at 89a. The exemplary shuttle 82a is moved along tracks defined by the side plates 86a, 88a between the base ends and distal end 89a. The distal end 89a would be positioned adjacent to a slot such as slot 28 shown in FIG. 1, whereby a user of the ATM would grasp currency notes from the shuttle 82a, through a slot such as the slot 28, when the shuttle 82a is positioned at the distal end 89a.

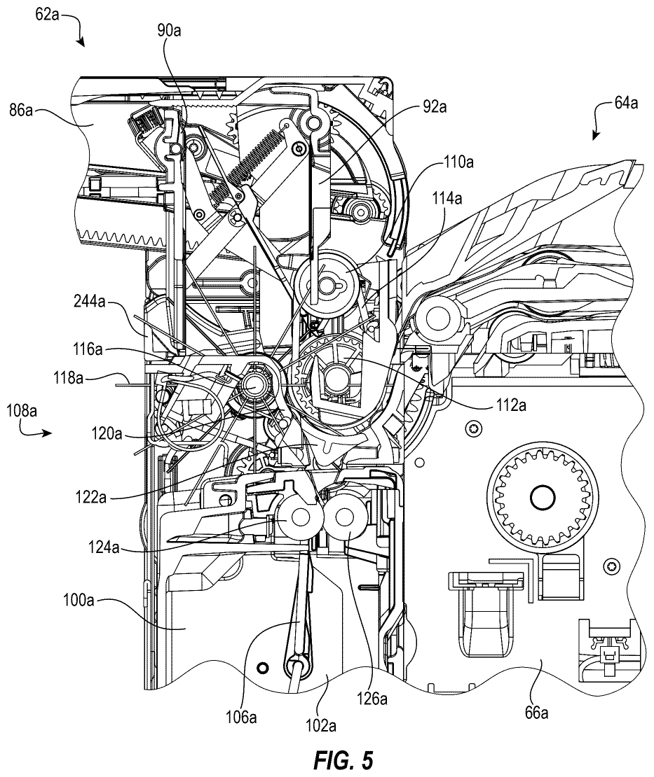

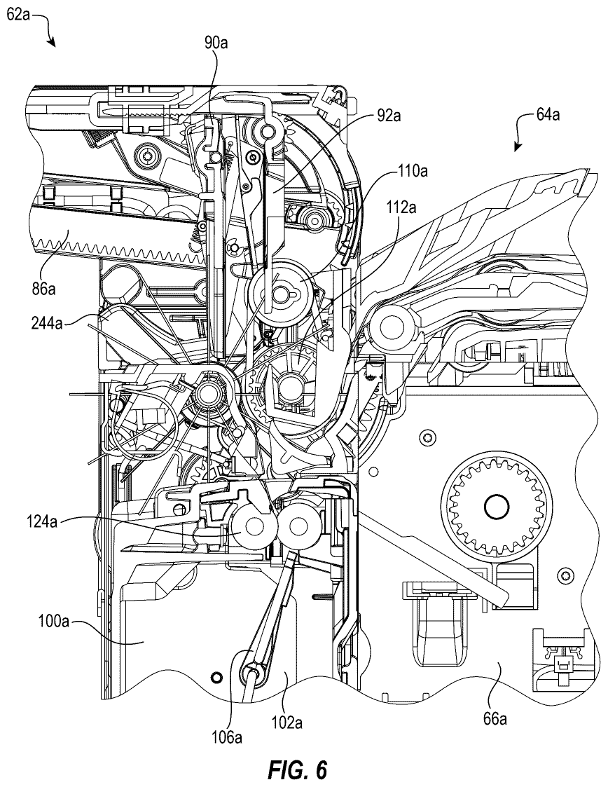

Referring now to FIG. 4, the exemplary shuttle 82a includes first and second plates 90a, 92a interconnected with a scissor linkage 94a. The location 84a is between the exemplary plates 90a, 92a. The exemplary scissor linkage 94a permits the exemplary plates 90a, 92a to remain interconnected while a space or gap between the exemplary plates 90a, 92a is varied to accommodate different stack sizes of currency notes. The exemplary shuttle 82a can include one or more springs to bias the exemplary plates 90a, 92a toward one another and thus minimize the gap. FIG. 5 shows the plates 90a, 92a separated a first distance apart, FIG. 6 shows the plates 90a, 92a separated a second distance apart, and the first distance is greater than the second distance. Currency notes that are directed to the exemplary shuttle 82a are stacked so that the edges of the notes are aligned and the stack of notes is generally cubic.

The exemplary shuttle assembly 62a also includes side cover plates 168a, 170a that overlay the side plates 86a, 88a. The exemplary shuttle assembly 62a also includes an end cover plate 172a. The exemplary shuttle assembly 62a also includes a shutter 174a to selectively open and close the slot 28, which defines an outlet. The exemplary shuttle assembly 62a also includes cross plates 176a and 178a.

Referring again to FIGS. 3 and 4, the exemplary currency transport assembly 40a also includes a cassette for holding reject bills and retract bills. The exemplary cassette is referenced at 96a. The exemplary cassette 96a includes an interior and a partition assembly 98a positioned within the interior. The exemplary partition assembly 98a separates the interior of the exemplary cassette 96a into a first volume 100a and a second volume 102a. The exemplary partition assembly 98a includes a partition 104a and a gate 106a. The exemplary gate 106a is positioned in the exemplary cassette 96a. The exemplary gate 106a is pivotally mounted to the exemplary partition 104a about a pivot axis 138a. It is noted that the terms pivot and rotate, as well as forms of those words, are used as synonyms herein.

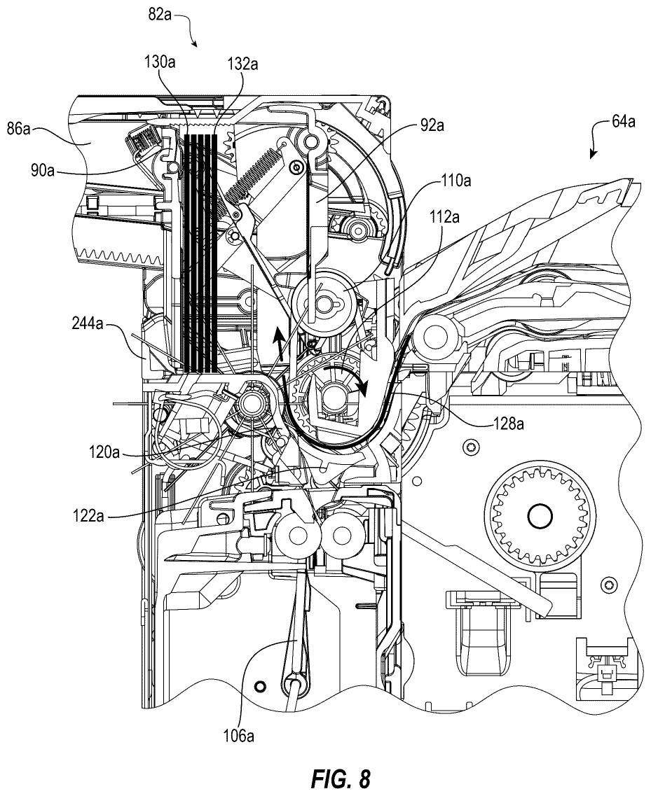

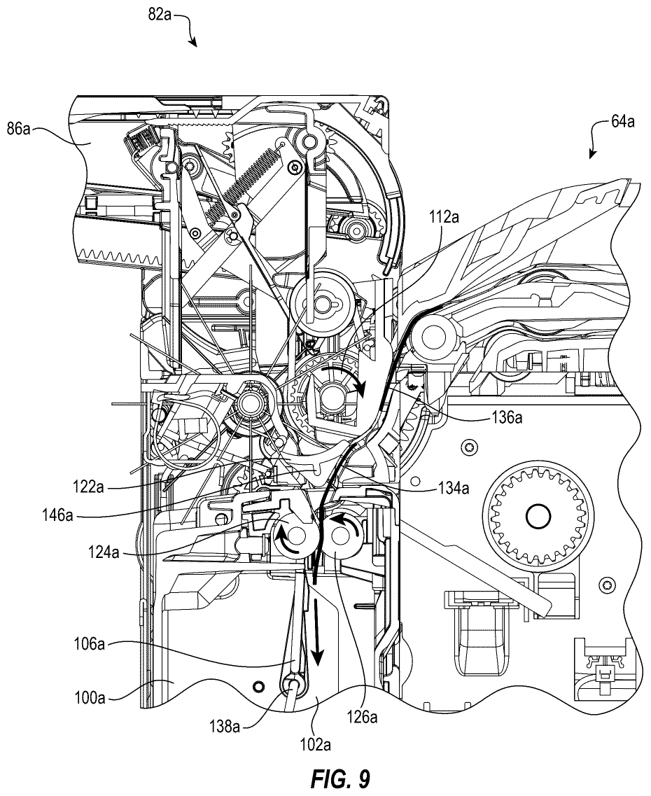

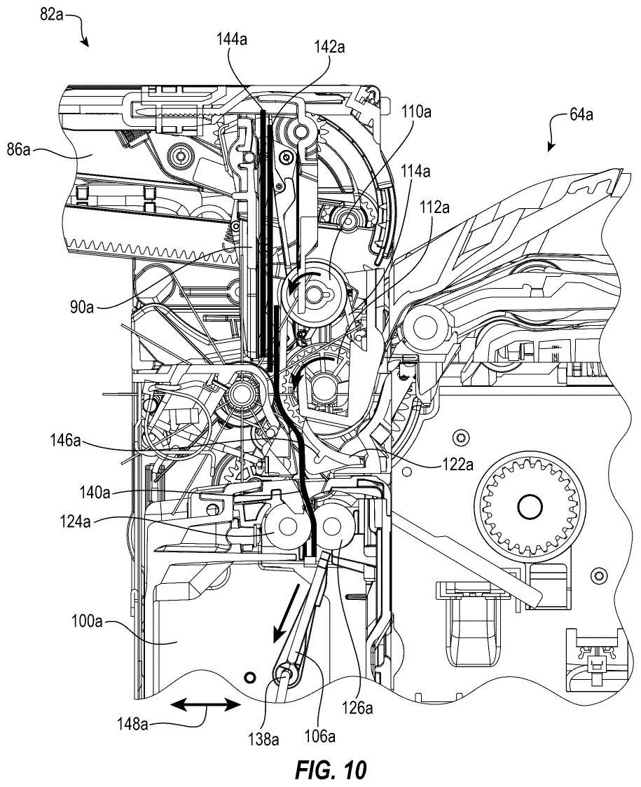

Referring to FIGS. 5-7, the exemplary shuttle assembly 62a and the exemplary note transport 64a interface at a routing portion of the exemplary currency transport assembly 40a, referenced generally at 108a. The exemplary routing portion 108a includes a thump roller 110a, a transport or feed wheel 112a, a thump drive belt 114a, a paddle wheel 116a having paddles such as paddle 118a, a guide plate 120a, a gate 122a, and rollers 124a, 126a. The exemplary thump drive belt 114a interconnects the exemplary thump roller 110a and the exemplary transport/feed wheel 112a for concurrent rotation. It is noted that in the Figures in which the paddles 118a are shown, the paddles 118a are shown in an undeformed condition. When installed and operating in the exemplary currency transport assembly 40a, the paddles 118a are deformed. It is also noted that the exemplary gate 122a is moveable between a first position shown in FIG. 9, a second position shown in FIG. 8, and a third position shown in FIG. 10.

FIG. 8 shows the movement of currency notes from the note transport 64a to the exemplary location 84a, between the exemplary plates 90a, 92a, of the exemplary shuttle 82a. Such notes could then be presented to a user of the ATM as a cash withdrawal. The exemplary shuttle 82a would receive the currency notes while at the location shown in FIG. 8 and can then be rotated to a horizontal orientation and then moved to the distal end 89a. Currency notes can be drawn out of a currency cassette held in the exemplary rack 66a, directed through one of the ports 76a, 78a, 80a onto the note pathway defined within the exemplary note transport 64a, and fed into engagement with the transport/feed roller 112a. Based on the perspective of FIG. 8, the exemplary transport/feed roller 112a rotates in the clockwise (CW) direction to move a currency note, such as exemplary currency note 128a, from the exemplary note transport 64a to the exemplary shuttle 82a. During this movement, the exemplary currency note 128a passes between the exemplary transport/feed roller 112a and the exemplary gate 122a (in its second position) and then between the exemplary transport/feed roller 112a and the exemplary guide plate 120a. FIG. 8 also shows several currency notes that were previously moved into the exemplary shuttle 82a and stacked on one another with edges aligned and generally cubic, such as exemplary currency notes 130a, 132a.

FIG. 9 shows the movement of currency notes to the exemplary portion 102a of the interior of the exemplary cassette 96a. Such notes could be reject bills. Currency notes can be directed through the note transport 64a and fed into engagement with the transport/feed roller 112a. Based on the perspective of FIG. 8, the exemplary transport/feed roller 112a rotates in the CW direction to move a currency note, such as exemplary reject currency notes 134a, 136a to the exemplary portion 102a. During this movement, the exemplary currency note 128a passes around the exemplary gate 122a. It is noted that the exemplary gate 122a would be pivoted counterclockwise (CCW) about a pivot axis 146a from the position shown in FIG. 8 to its first position. After passing the exemplary gate 122a, the currency notes 134a, 136a pass between the exemplary rollers 124a, 126a and are then diverted by the gate 106a to pass into the exemplary portion 102a of the interior of the exemplary cassette 96a. Based on the perspective of FIG. 9, the gate 106a is pivoted CCW about its pivot axis 138a to permit the movement of the currency notes 134a, 136a into the exemplary portion 102a of the interior of the exemplary cassette 96a.

FIG. 10 shows the movement of currency notes from the exemplary shuttle 82a to the exemplary portion 100a of the interior of the exemplary cassette 96a. Such notes could be retract notes. FIG. 10 shows three exemplary currency notes 140a, 142a, 144a. FIG. 10 shows the currency note 140a during movement, generally midway between the exemplary shuttle 82a and the exemplary portion 100a. Currency notes 142a and 144a are shown in their initial positions within the exemplary shuttle 82a, where movement of the note 140a would have begun. When the movement of currency notes from the exemplary shuttle 82a to the exemplary portion 100a begins, the note 140a would be stacked with the notes 142 and 144a, as the notes 130a, 132a, and the notes therebetween are shown in FIG. 8.

Referring again to FIG. 10, the movement of the notes 140a, 142a, 144a begins when the exemplary thump roller 110a and transport/feed roller 112a start rotating in the CCW direction, based on the perspective of FIG. 10. The notes 140a, 142a, 144a are pressed against the exemplary thump drive belt 114a by the plate 90a. Engagement between the exemplary thump drive belt 114a and the note 140a causes the note 140a to move downward, based on the perspective of FIG. 10. Also, as shown in FIG. 10, the exemplary gate 122a has been pivoted CW to its third position from its second position shown in FIG. 8 about the pivot axis 146a to permit movement of the note 140a to the exemplary portion 100a. After passing the exemplary gate 122a, the currency note 140a passes between the exemplary rollers 124a, 126a and is then diverted by the gate 106a to pass into the exemplary portion 100a of the interior of the exemplary cassette 96a. The exemplary gate 106a has been rotated CW from its position shown in FIG. 9.

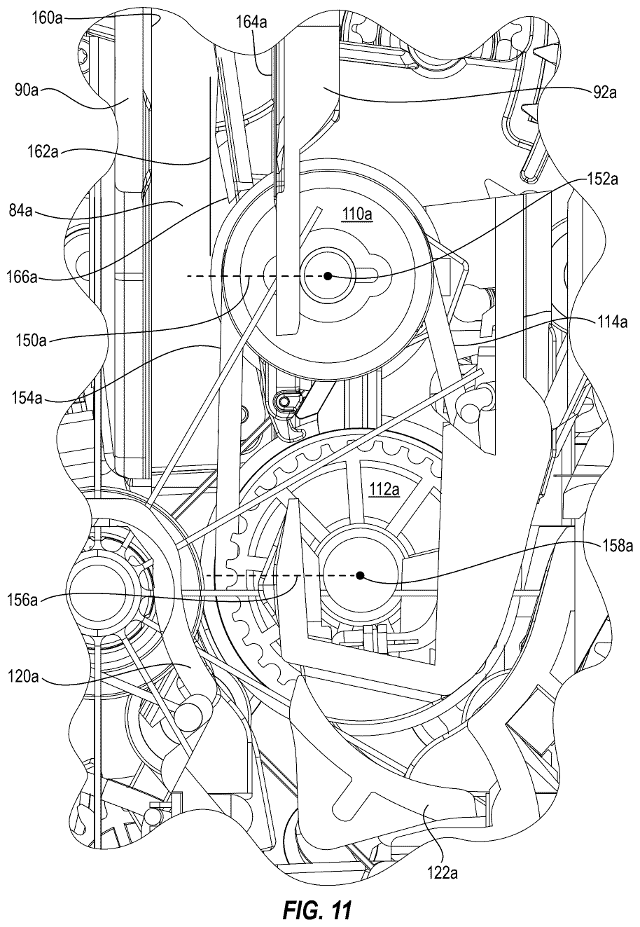

FIGS. 10 and 11 also show how the notes 140a, 142a, 144a can be arranged in a shingled pattern when directed into the exemplary portion 100a. The shingled pattern can be desirable to allow a depth of the portion 100a (referenced by arrow 148a) to be reduced and/or minimized; notes in a shingled arrangement are “spread out” relative to notes that are stacked with respect to one another.

Shingling between the exemplary currency notes 140a and 142a is accomplished when the exemplary notes 140a, 142a, 144a reach the position shown in FIG. 10. At some point after the downward movement of the “forward most” note, the exemplary note 140a, begins, a top edge of the exemplary note 140a will not fully cover the portion of the outer surface area of the exemplary thump drive belt 114a that is facing directly toward the exemplary plate 90a. This part of the outer surface area of the exemplary thump drive belt 114a appears in side view in FIG. 11 and is referenced at 154a.

A top edge of the exemplary note 140a shown in FIG. 10 will come to be below an axis 150a shown in FIG. 11 at some point during downward movement of the exemplary note 140a. The exemplary axis 150a is normal to an axis 152a of rotation of the roller 110a and is also normal to the surface portion 154a. The exemplary surface portion 154a is flat and is within a plane referenced at 162a.

FIG. 11 also references an exemplary axis 156a. The axis 156a is parallel to the axis 150a. The exemplary axis 156a is normal to an axis 158a of rotation of the roller 112a. The exemplary axis 156a is also normal to the surface portion 154a. The exemplary surface portion 154a extends between the axes 150a and 156a.

The exemplary plate 90a defines a first planar surface 160a that is parallel to the exemplary plane 162a. The exemplary plate 92a defines a second planar surface 164a that confronts the first planar surface 160a. Currency notes are pressed between the surfaces 160a and 164a.

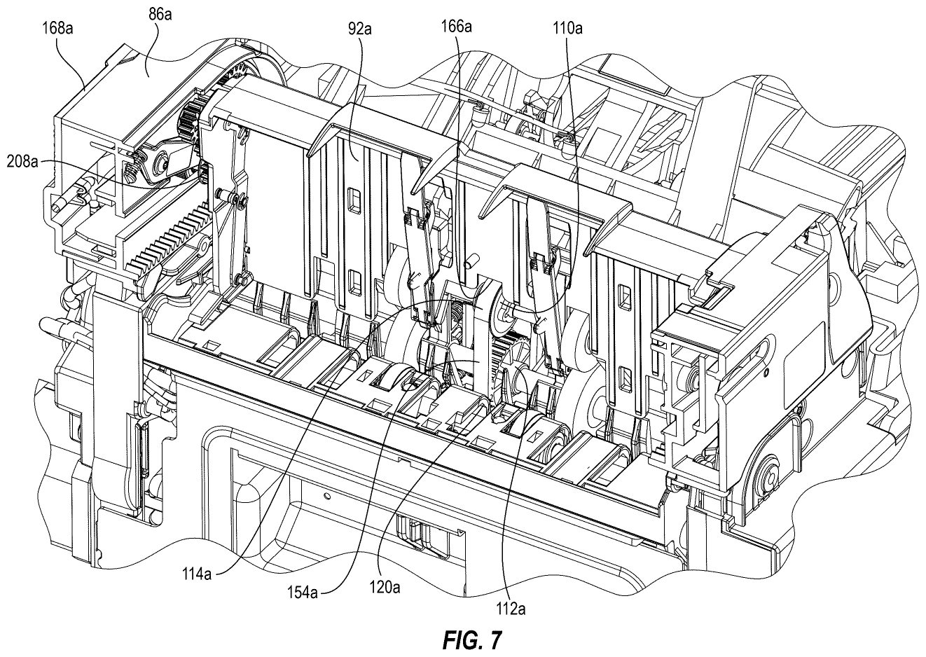

The exemplary plate 92a includes a notch 166a best shown in FIGS. 7 and 11. When the shuttle 82a returns from the distal end 89a with retract currency notes such as notes 140a, 142, 144a, the rollers 110a and 112a partially extend through the notch 166a and the surface portion 154a is closer to the planar surface 160a than the planar surface 164a. As a result, retract notes held by the shuttle 82a are pressed between the planar surface 160a and the surface portion 154a.

Referring further to FIGS. 10 and 11, since the plate 90a is pressing the notes 140a, 142a, and 144a against the surface portion 154a, when the top edge of the exemplary note 140a moves below the axis 150a, the next currency note in the stack that is positioned in the shuttle 82a comes into contact with the part of the surface portion 154a that is not engaged with the exemplary note 140a. In the present example, this would be the exemplary note 142a. When the exemplary note 142a comes into contact with the part of the surface portion 154a that is not engaged with the exemplary note 140a, the exemplary note 142a will be moved downward by the belt 114a. Thus, both of the exemplary notes 140a and 142a would then be moving downward, with the respective top edges of the exemplary notes 140a and 142a spaced from one another or shingled with respect to one another. When a top edge of the note 142a moves below the axis 150a, the note 144a will then come into engagement with the exemplary thump drive belt 114a, which causes the exemplary note 144a to move downward. Shingling allows the notes to eventually be neatly stacked next to each other. If the notes were not shingled relative to one another, notes might jam and be stacked on top of each other, increasing a depth of the stack of notes (the depth defined along the arrow 148a).

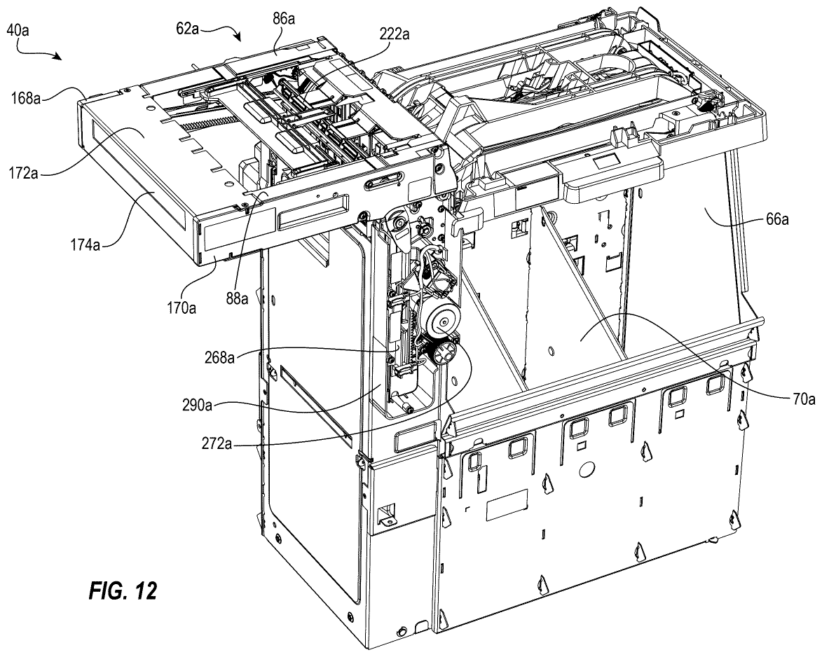

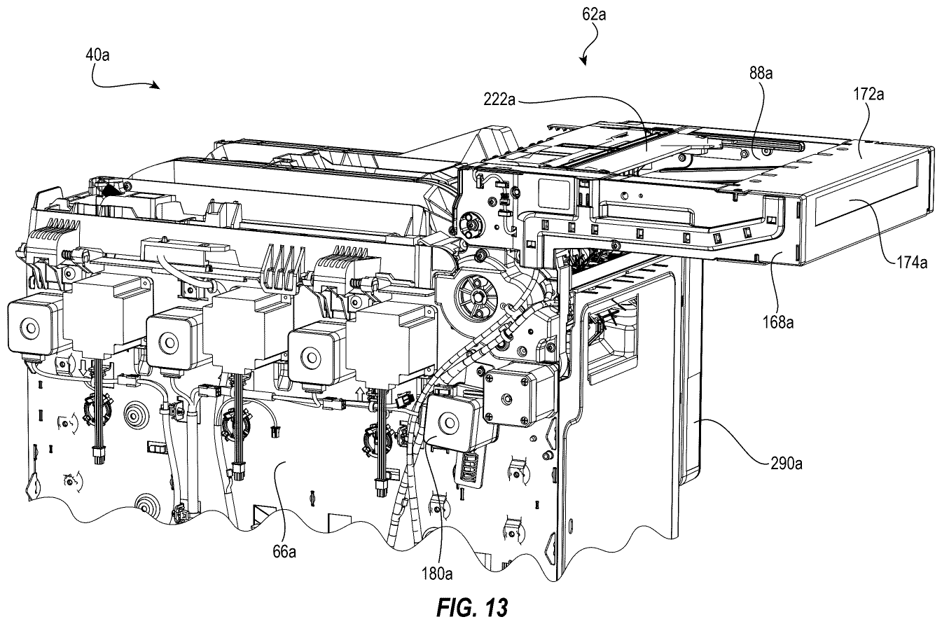

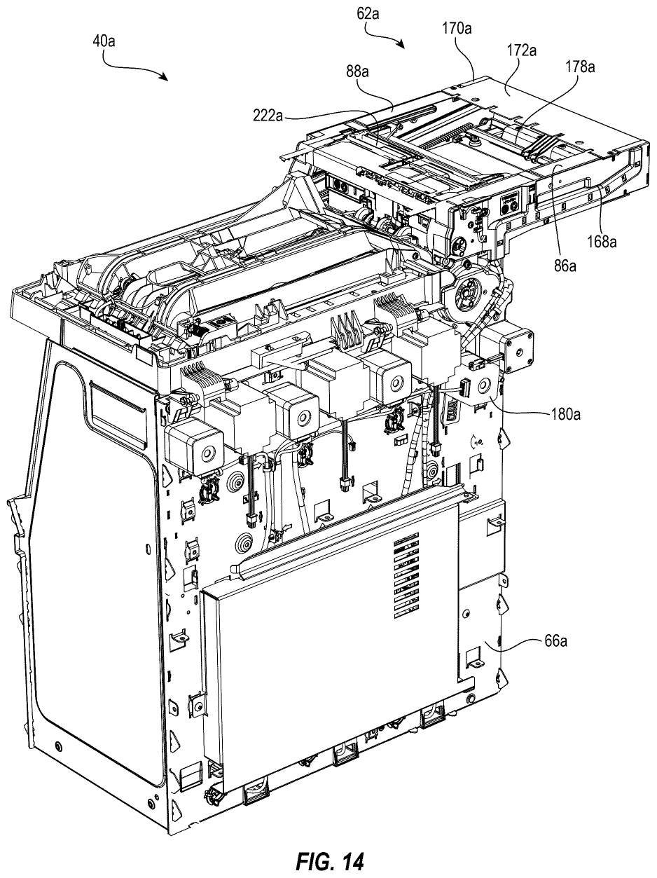

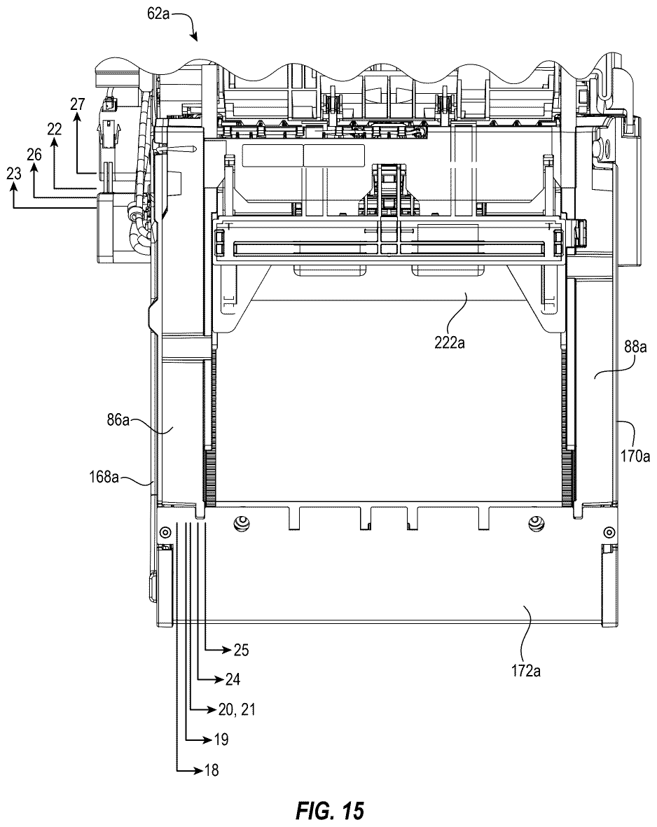

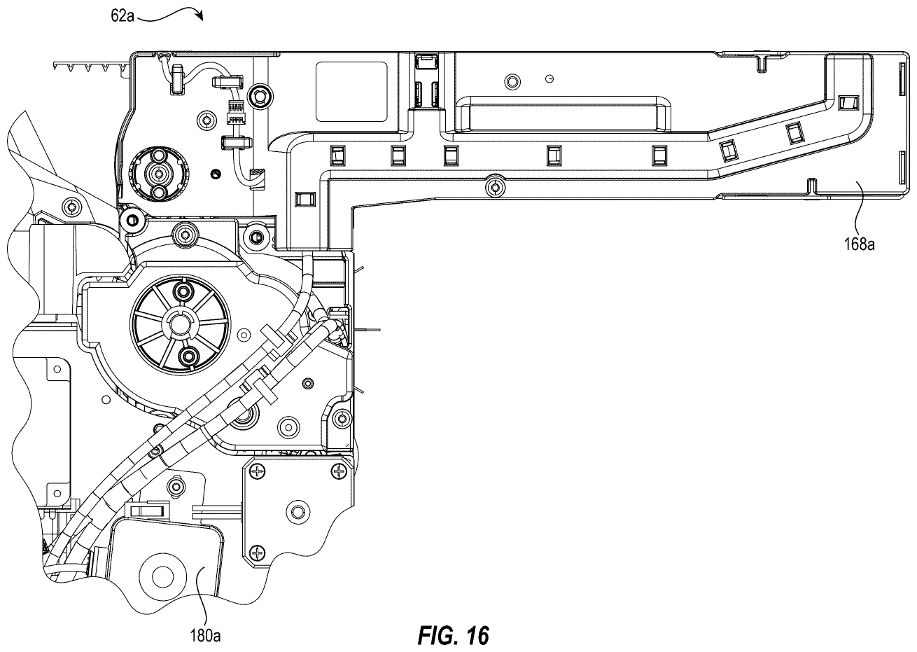

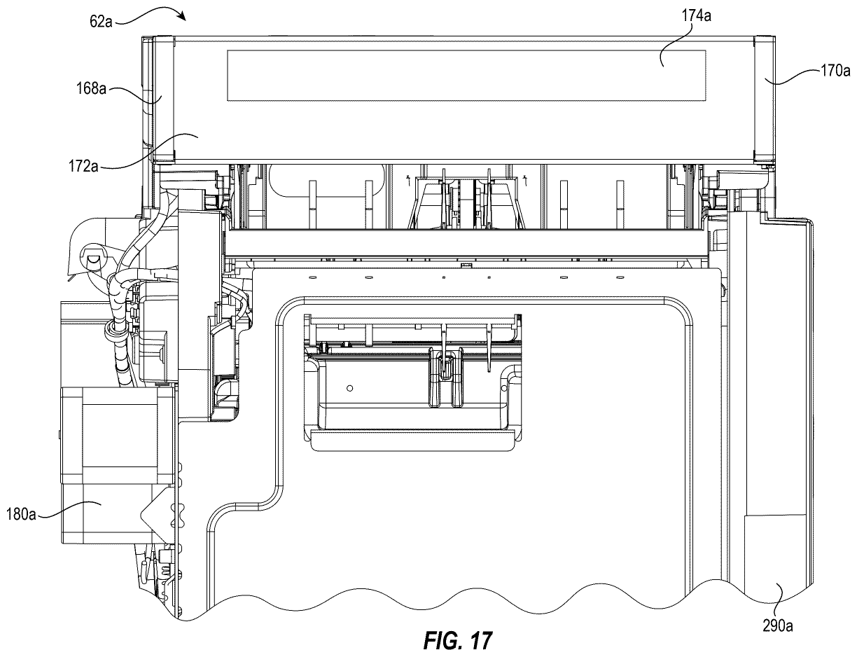

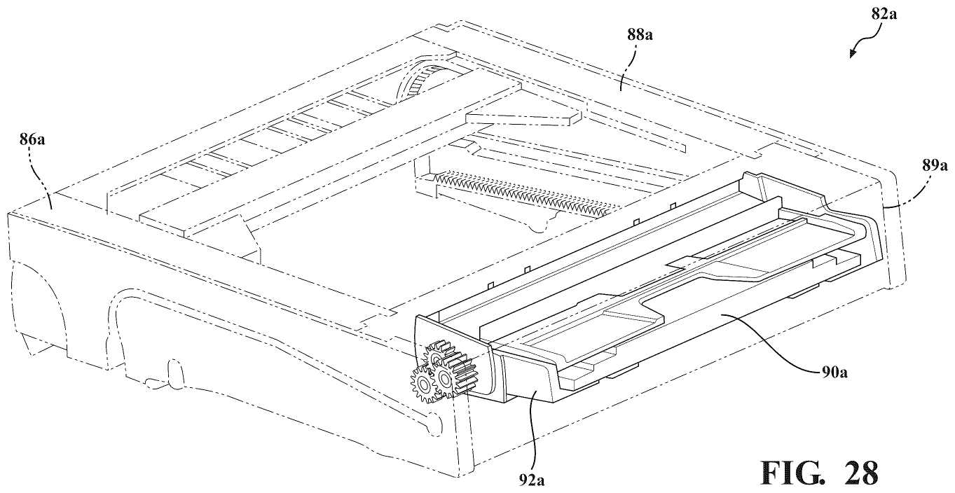

FIGS. 12-17 are additional views of the exemplary currency transport assembly 40a. Referring now to FIGS. 13 and 14, the exemplary currency transport assembly 40a includes a motor 180a with an output shaft 181a. The exemplary motor 180a can rotate the output shaft 181a in both the clockwise direction and the counter-clockwise direction. The exemplary motor 180a provides power for moving the exemplary shuttle 82a, as will be described in greater detail below. Generally, the exemplary shuttle 82a can be moved rectilinearly to and from a first rectilinear position at the distal end 89a that is shown in FIG. 28. When at its first rectilinear position, the exemplary shuttle 82a can operate to present currency notes to a user or can receive currency notes from the user. In addition, the exemplary shuttle 82a can be moved to and from a second rectilinear position that is shown at FIGS. 4-6, 8-11, 23, and 25, for example. When at the second rectilinear position, the exemplary shuttle 82a can operate to present currency notes for further movement to one of the cassettes positioned in one of the bays 70a or to one to the portion 100a. When at the second rectilinear position, the exemplary shuttle 82a can also operate to receive currency notes from one of the cassettes. The second rectilinear position can be viewed as a “home” position. As will be detailed below, in the exemplary embodiment, power provided by the motor 180a is utilized to produce the rectilinear movement between the first and second positions.

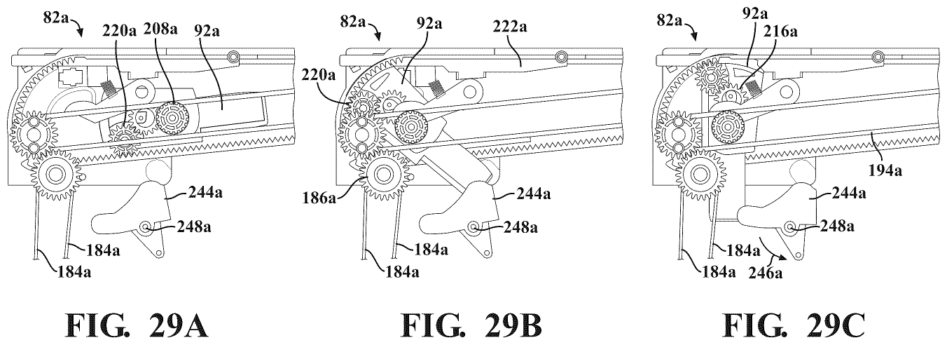

In addition to rectilinear movement between the first and second positions, the exemplary shuttle 82a can also be rotated. FIGS. 29A-C are sequential side images during movement of the exemplary shuttle 82a from the first rectilinear position to the second rectilinear position and, further, movement in the form of rotation between a horizontal orientation and a vertical orientation. When the exemplary shuttle 82a reaches the second rectilinear position, it can be rotated as shown in FIGS. 29B and 29C. As will be detailed below, in the exemplary embodiment, power provided by the motor 180a is utilized to produce the rotational movement between the horizontal orientation and the vertical orientation.

As set forth above, further movement associated with the exemplary shuttle 82a occurs. Specifically, the exemplary plates 90a, 92a can be biased toward one another but can be moved apart from one another against any biasing forces. As will be detailed below, in the exemplary embodiment, power provided by the motor 180 is utilized to produce this separating movement.

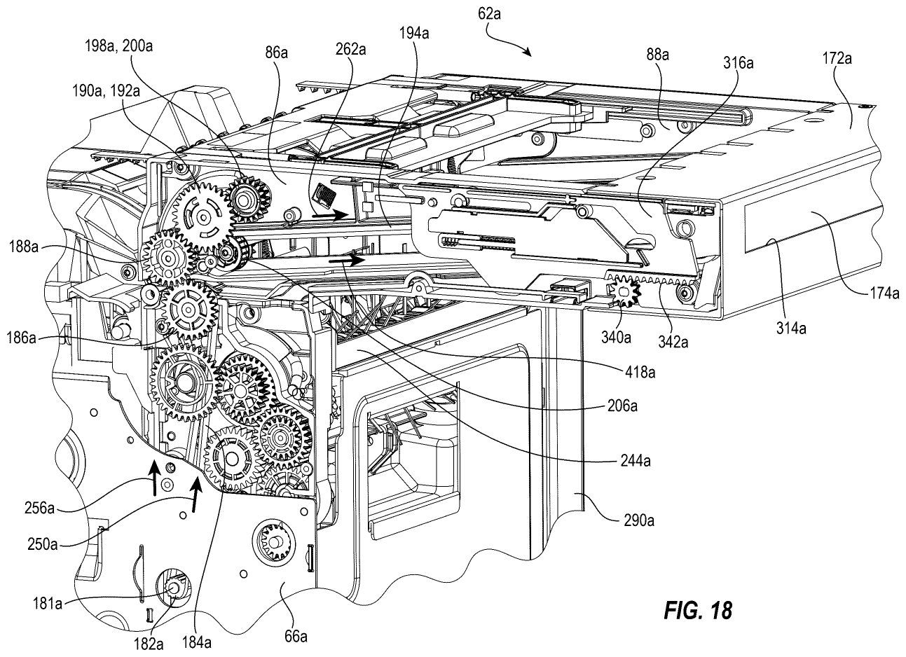

In the exemplary embodiment, with reference to FIG. 18, the shaft 181a of the motor 180a is received in a pulley 182a. The exemplary motor 180a can drive the pulley 182a in rotation in the CW direction. Also, the operation of the exemplary motor 180a can be reversed so that the exemplary motor 180a can also drive the pulley 182a in rotation in the CCW direction.

Referring further to FIG. 18, the exemplary pulley 182a is partially encircled by a belt 184a. Thus, rotation of the exemplary pulley 182a results in movement of the exemplary belt 184a. FIG. 18 is a partial cross-section, so a portion of the exemplary belt 184a is hidden. The exemplary belt 184 a also partially encircles a gear-pulley 186a. The exemplary gear-pulley 186a includes a pulley portion around which the exemplary belt 184a extends. Thus, movement of the exemplary belt 184a results in rotation of the gear-pulley 186a. The exemplary gear-pulley 186a also includes a gear portion. In FIG. 18, based on the perspective of view, the pulley portion is behind the gear portion.

Referring further to FIG. 18, teeth of the gear portion of the exemplary gear-pulley 186a are meshed with teeth of a gear-pulley 188a of the exemplary shuttle assembly 62a. The exemplary gear-pulley 188a is positioned between the side plate 86a and the side cover plate 168a. The exemplary gear-pulley 188a is mounted for rotation on the side plate 86a. The exemplary gear-pulley 188a includes a gear portion and a pulley portion. In FIG. 18, based on the perspective of view, the pulley portion of the exemplary gear-pulley 188a is behind the gear portion of the exemplary gear-pulley 188a. The teeth of the gear portion of the exemplary gear-pulley 186a are meshed with the teeth of the gear portion of the exemplary gear-pulley 188a. Thus, rotation of the exemplary gear-pulley 186a results in rotation of the exemplary gear-pulley 188a. The pulley portion of the exemplary gear-pulley 188a includes ribs that project radially outward, to better engage a belt that will be described in greater detail below.

Rotation of the exemplary gear-pulley 188a is transmitted to a plurality of distinct motion pathways. In a first motion pathway, the teeth of the gear portion of the exemplary gear-pulley 188a mesh with teeth of a first gear 192a of a laminated or double gear 190a of the exemplary shuttle assembly 62a. In a second motion pathway, the pulley portion of the exemplary gear-pulley 188a is partially encircled by a belt 194a. Thus, rotation of the exemplary gear-pulley 188a results in rotation of exemplary double gear 190a and results in movement of the exemplary belt 194a.

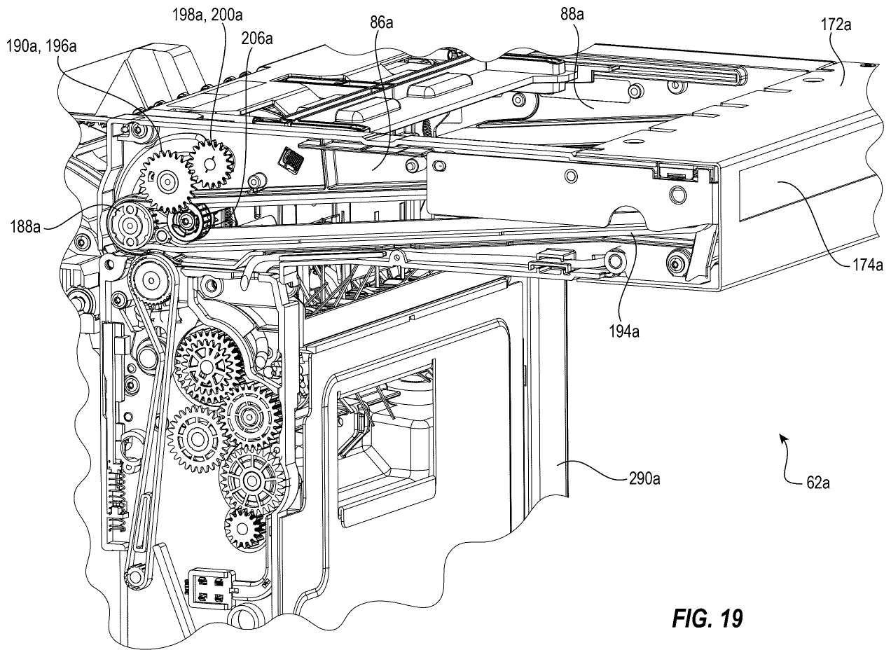

The exemplary double gear 190a is mounted for rotation on the side plate 86a and is positioned between the side plate 86a and the side cover plate 168a. The exemplary double gear 190a includes the first gear 192a and a second gear 196a referenced in FIG. 19. Teeth of the exemplary second gear 196a mesh with teeth of a first gear 200a of a double gear 198a of the exemplary shuttle assembly 62a. Thus, rotation of the exemplary double gear 190a results in rotation of exemplary double gear 198a.

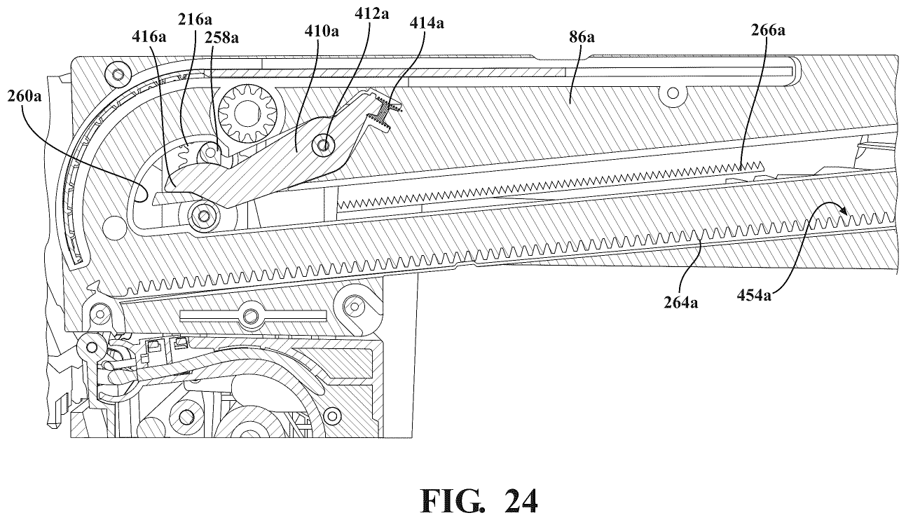

The exemplary double gear 198a is mounted for rotation on the side plate 86a and the exemplary first gear 200a is positioned between the side plate 86a and the side cover plate 168a. FIG. 23 shows a cross-section through a vertical, front-to-back plane and the center axis of the exemplary double gear 198a is contained in that plane. As shown in FIG. 23, the exemplary double gear 198a also includes a barrel portion 202a and a second gear 204a.

Referring again to FIG. 18, in the second motion pathway, the exemplary belt 194a is engaged with a pulley 206a of the exemplary shuttle assembly 62a. The exemplary pulley 206a is positioned between the side plate 86a and the side cover plate 168a. The exemplary pulley 206a is mounted for rotation, which will be described in greater detail below. The exemplary pulley 206a includes ribs that project radially outward to better engage the belt 194a.

As shown in FIG. 18, the exemplary pulley 206a is positioned between opposing sections of the exemplary belt 194a. The exemplary pulley 206a engages a top section of the exemplary belt 194a (based on the perspective of FIG. 18) and is spaced from the opposing bottom section of the exemplary belt 194a. When the exemplary belt 194a moves, the exemplary pulley 206a rotates and may also moves rectlinearly, as will be detailed below. The exemplary pulley 206a can moves rectilinearly in the same direction that the top section of the belt 194a is moving.

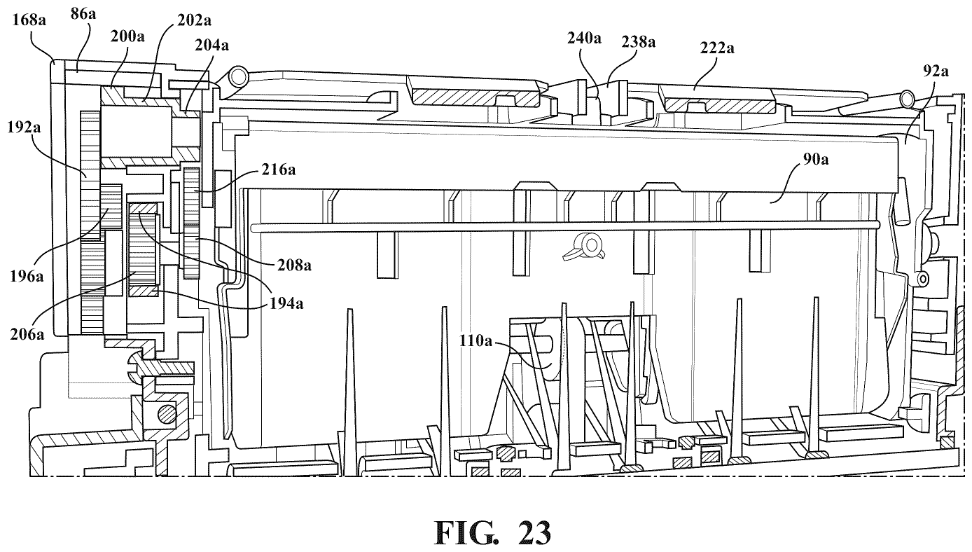

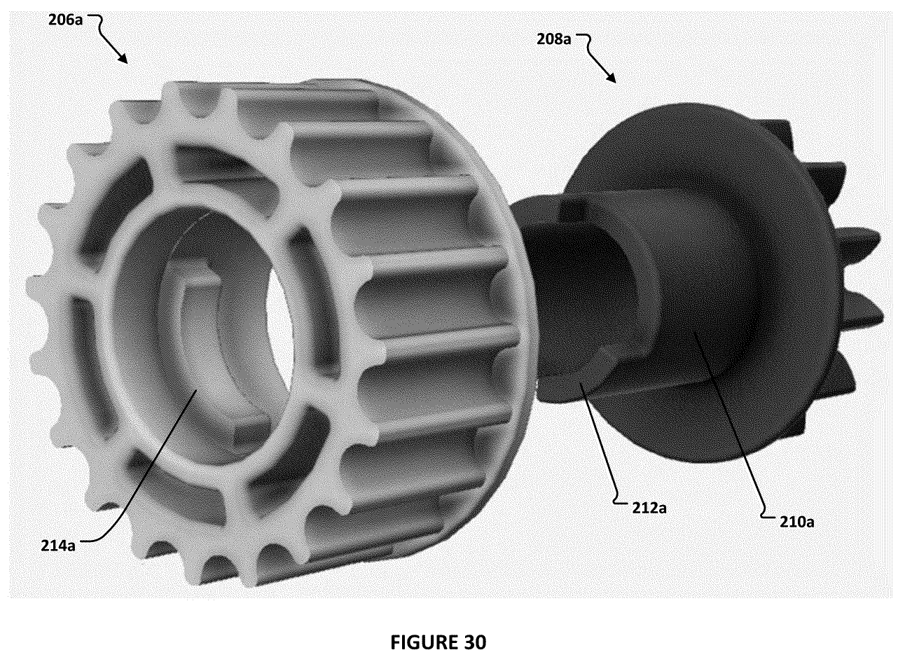

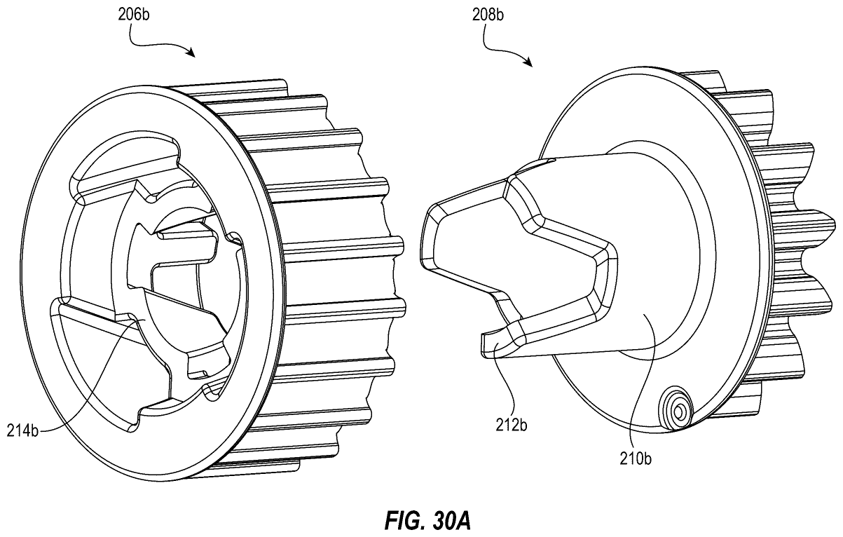

As set forth above, the exemplary pulley 206a is mounted for rotation. Referring now to FIG. 30, the exemplary pulley 206a is mounted for rotation on a shaft portion 210a of a gear 208a of the exemplary shuttle assembly 62a. The exemplary gear 208a is mounted for rotation on a post 448a extending from the plate 92a. The exemplary pulley 206a and the exemplary gear 208a are fixed for rotation together by interlocking notches, such as referenced at 212a and 214a in FIG. 30. The exemplary notches 212a, 214a circumferentially abut one another about a central axis of the exemplary pulley 206a and the exemplary gear 208a when the exemplary pulley 206a is received on the exemplary shaft portion 210a of the exemplary gear 208a. FIG. 22 shows a cross-section through a vertical, front-to-back plane and the center axis of the exemplary pulley 206a and the exemplary gear 208a is contained in that plane.

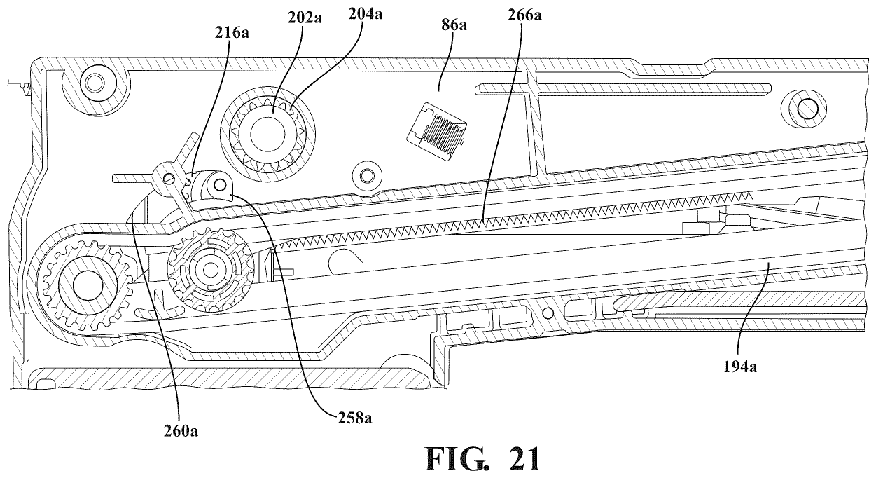

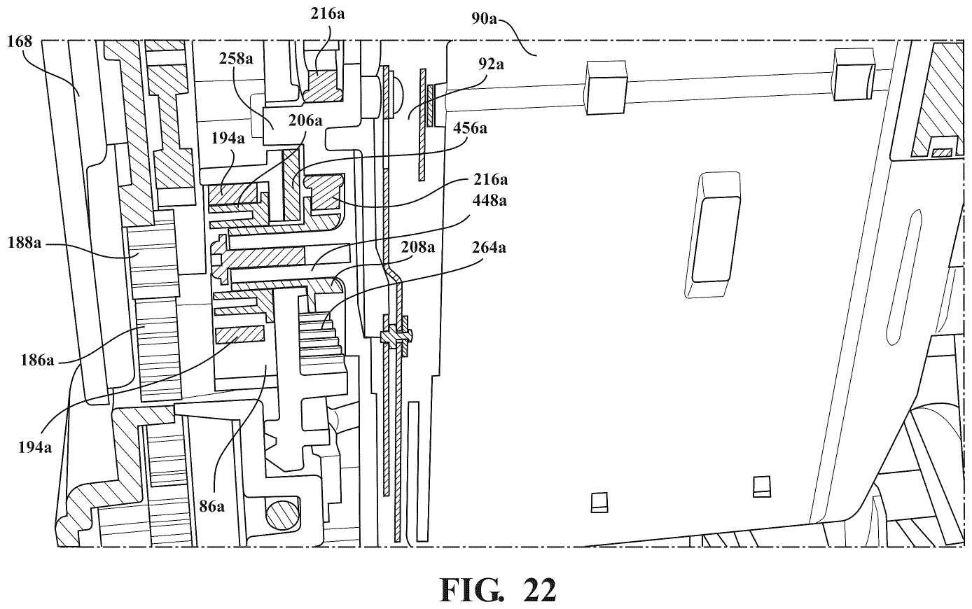

FIG. 21A is a planar sectional view similar to FIG. 21 but of an alternative embodiment of the present disclosure. FIG. 21A shows an alternative slot 260b. Side plate 86b, second gear 204b of double gear 198b, gear 216b, track portion 266b, belt 194b, and post 258b are also referenced in FIG. 21A.

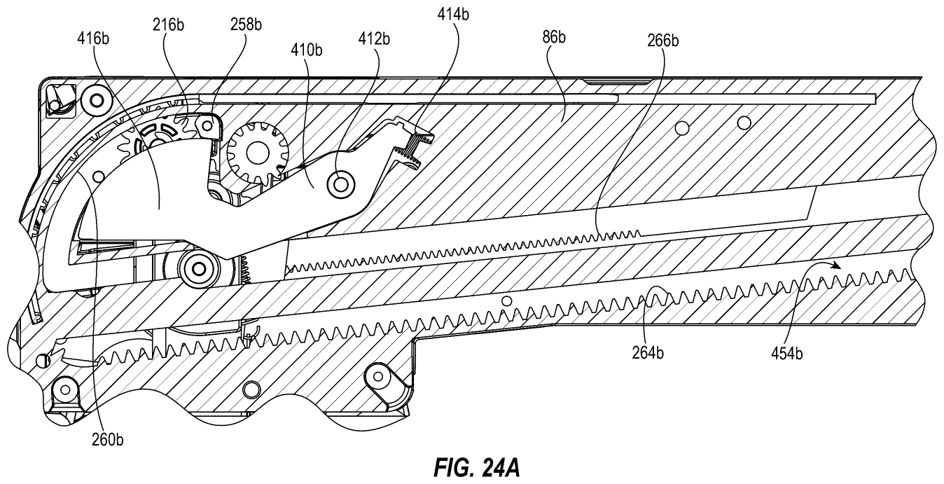

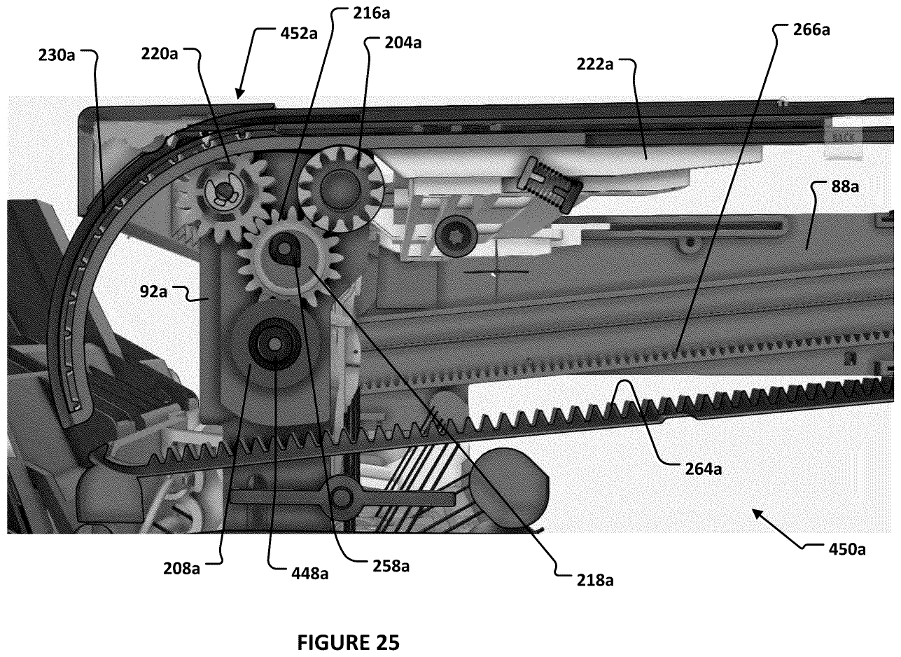

FIG. 24A is a perspective and sectional view similar to FIG. 24 but of an alternative embodiment of the present disclosure. FIG. 24A shows an alternative arm 410b having an end 416b. Side plate 86b, gear 216b, track portion 266b, post 258b, axis 412b of rotation, spring 414b, track portions 266b and 264b, slot 260b, and second end 454b are also referenced in FIG. 24A.

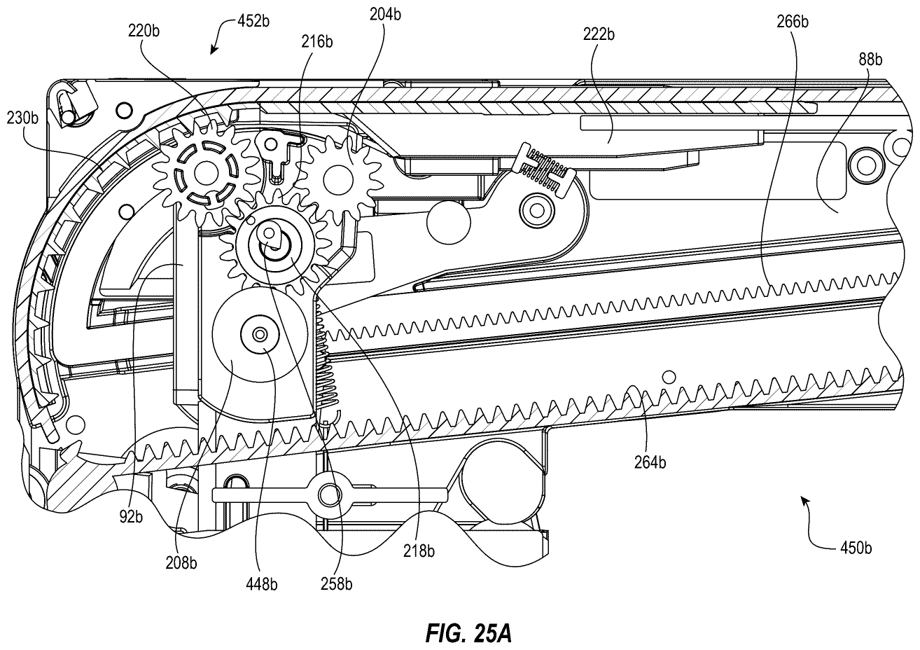

Referring now to FIG. 25, the exemplary shuttle assembly 62a also includes a gear 216a. The exemplary gear 216a is mounted for rotation on a shaft portion 218a of the plate 92a. The teeth of the exemplary gear 216a mesh with teeth of the exemplary gear 208a. As will be set forth in greater detail below, the teeth of the exemplary gear 216a mesh with the teeth of the exemplary gear 204a during first predetermined periods of operation and are spaced from the teeth of the exemplary gear 204a during second predetermined periods of operation.

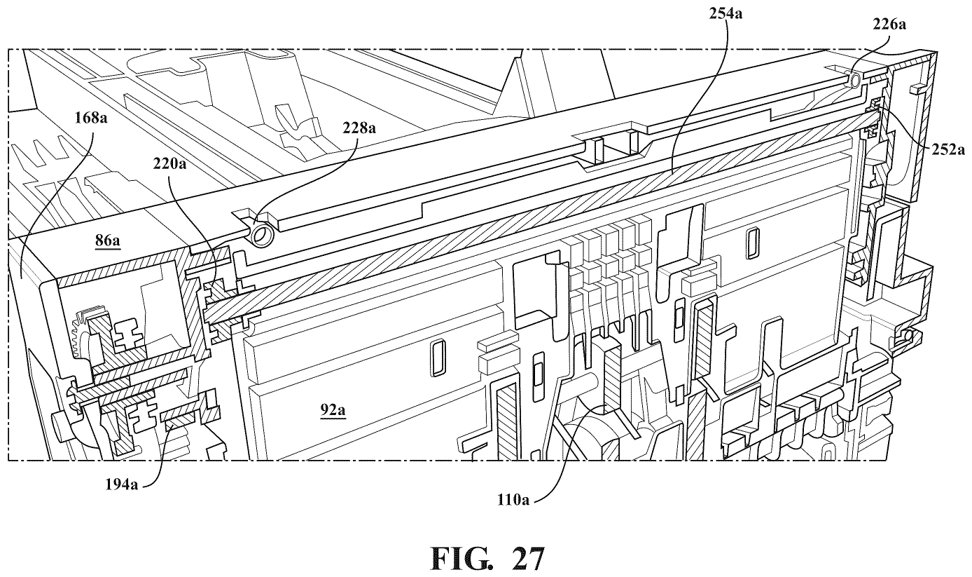

Referring again to FIGS. 25 and 27, the exemplary shuttle assembly 62a also includes a gear 220a. The exemplary gear 220a is mounted for rotation on a shaft 254a that extends through the plate 92a. The teeth of the exemplary gear 220a mesh with teeth of the exemplary gear 216a. The exemplary gear 220a is positioned closer to the front side of the assembly 40a and it is noted that a gear 252a, referenced in FIG. 27, is identical to gear 220a and is positioned closer to the back side of the assembly 40a. The two gears 220a, 252a are interconnected for concurrent rotation by the shaft 254a.

FIG. 30A is an exploded view similar to FIG. 30 but of an alternative embodiment of the present disclosure. FIG. 30A shows a pulley 206b and gear 208b having alternative shapes relative to the pulley 206a and gear 208a. Notches 212b and 214b and shaft portion 210b are also shown in FIG. 30A.

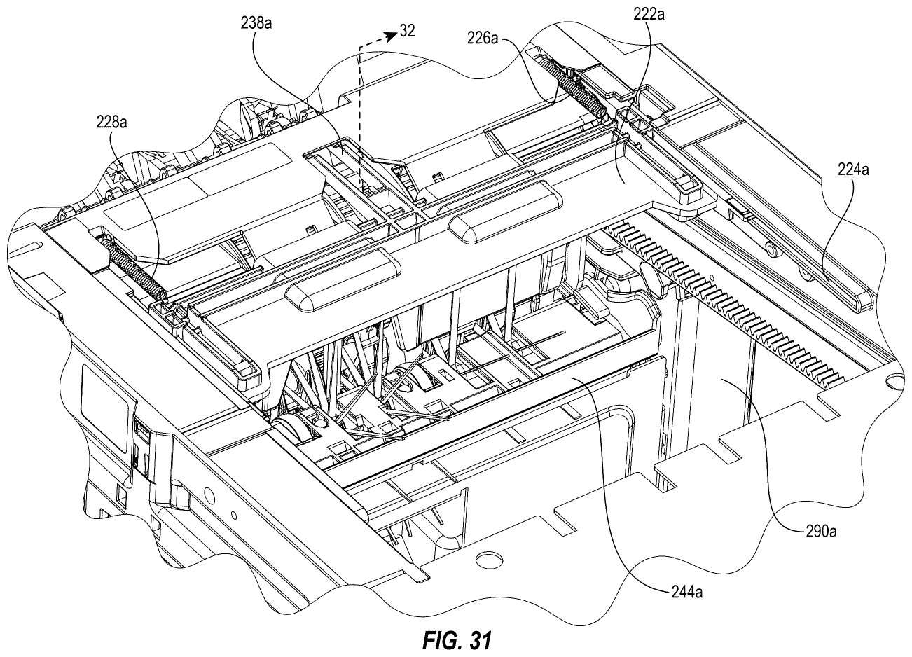

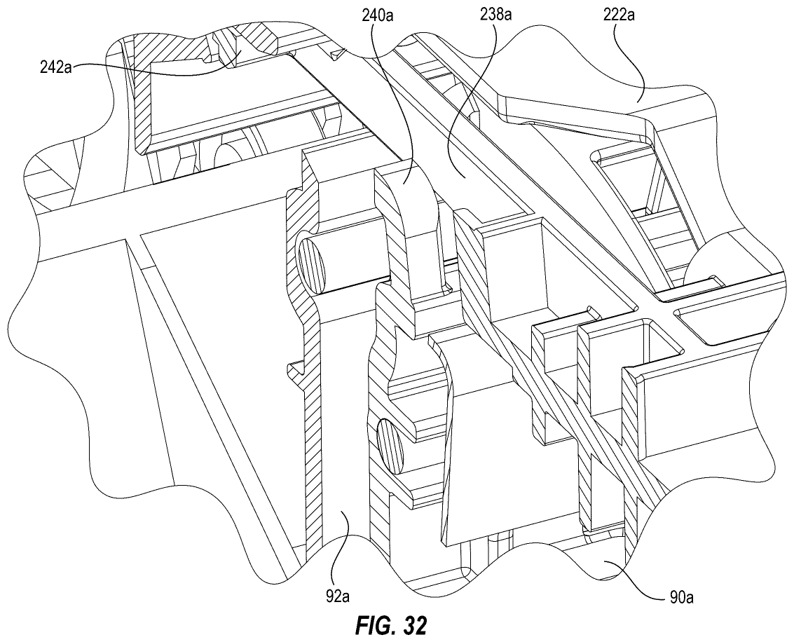

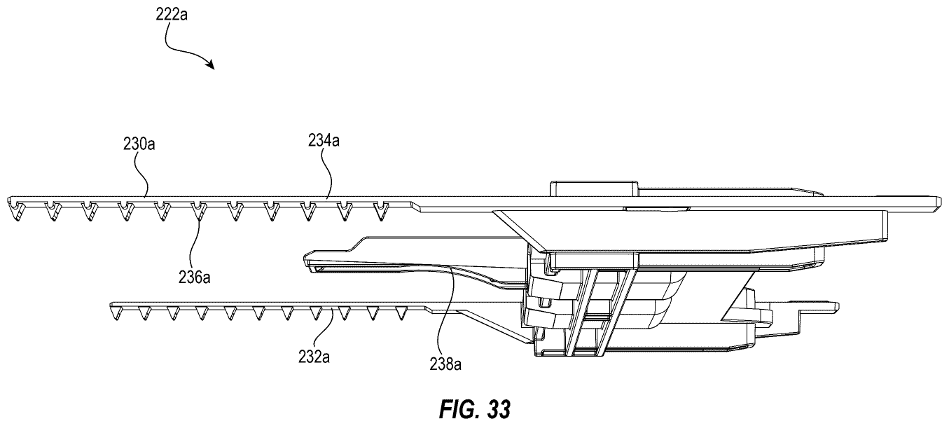

Referring now to FIG. 33, the exemplary shuttle assembly 62a also includes a latch 222a. The exemplary latch 222a is utilized to separate the plates 90a, 92a from one another. The exemplary latch 222a is received in slots defined by the sides plates 86a, 88a. The slot in side plate 88a is referenced at 224a in FIG. 31. The exemplary latch 222a moves rectilinearly, left to right, within the currency conveyor 40a, guided in movement by these slots. The exemplary latch 222a selectively moves from a first position (shown in FIGS. 31 and 32) to a second position spaced from the first position. In the second position, the exemplary latch 222a engages the plate 90a away from the plate 92a. With reference to FIG. 31, the exemplary latch 222a is biased to the left, to the first position, by springs 226a, 228a.

Referring again to FIG. 33, the exemplary latch 222a is integrally formed with first and second track portions 230a, 232a. “Integrally-formed” refers to the fact that in the exemplary embodiment the exemplary latch 222a and first and second track portions 230a, 232a are formed together rather than being formed separately and then subsequently joined. The term defines a structural feature since structures that are integrally-formed are structurally different than structures that are comprised of subcomponents formed separately and then subsequently joined. “Integral” means consisting or composed of parts that together constitute a whole and thus encompasses structures of more than one part wherein the parts are either integrally-formed or formed separately and then subsequently joined.

Referring again to FIG. 33, the exemplary latch 222a also includes first and second track portions 230a, 232a. The exemplary first and second track portions 230a, 232a include a backing portion and teeth projecting from the backing portion. For example, the exemplary first track portion 230a includes a backing portion 234a and teeth, such as tooth 236a, projecting from the backing portion 234a. The exemplary first and second track portions 230a, 232a are flexible. The exemplary first and second track portions 230a, 232a can bend and then straighten. The tracks defined by sides plates 86a, 88a include straight portions and curved portions. When the exemplary latch 222a is biased to the left, to the first position, the exemplary first and second track portions 230a, 232a are received in curved portions of the tracks defined by sides plates 86a, 88a, bent generally into a quarter circle, as the exemplary first track portion 230a is shown in FIG. 25. When the exemplary latch 222a is moved to its right-side end limit of travel (the second position, opposite to the first position shown in FIG. 31), the exemplary first and second track portions 230a, 232a are received in straight portions of the tracks defined by sides plates 86a, 88a and are thereby unbent.

With reference again to FIG. 33, the exemplary latch 222a also includes an aperture 238a. A projection 240a extends from the plate 90a and extends into the aperture 238a, as best shown in FIG. 32. When the exemplary latch 222a is biased to the left, the exemplary plates 90a, 92a are positioned closest to one another and the projection 240a is spaced from left side 242a of the aperture 238a. As will be described in greater detail below, when the exemplary latch 222a is moved to its right-side end limit of travel, the exemplary left side 242a will move toward the exemplary projection 240a, then come into contact with the exemplary projection 240a, and then move the exemplary projection 240a and the associated exemplary plate 90a to the right, away from the exemplary plate 92a, and against the biasing forces generated by the exemplary springs 226a, 228a.

As set forth above, the exemplary shuttle 82a is moveable between first and second rectilinear positions. As described and shown, the exemplary shuttle 82a is also rotatable between a generally horizontal orientation (FIG. 29A) and a generally vertical orientation (FIG. 29C). Referring now to FIGS. 29A-29C , the exemplary shuttle assembly 62a also includes a lock 244a that is rotatable between a locking position and an unlocked position. An exemplary locking position that is shown in FIG. 29C. When the exemplary lock 244a is in the locking position (FIG. 29C), the exemplary lock 244a engages the plate 92a and thereby precludes the exemplary shuttle 82a from rotating away from the vertical orientation. The exemplary lock 244a is rotated in a direction 246a about an axis 248a to move away from the locking position. When the exemplary lock 244a is rotated away from the locking position, the exemplary shuttle 82a can be rotated away from the vertical orientation and to the horizontal orientation.

Various operations of the exemplary shuttle 82a will now be described. In a first operation, the exemplary plates 90a, 92a are moved apart. Separating the exemplary plates 90a, 92a begins when the exemplary shuttle 82a is at the second rectilinear position and is in the vertical orientation; the lock 244a is the locking position. This position and orientation is shown in FIG. 29C. The exemplary latch 222a is initially at its left-most position. Referring initially to FIG. 18, the exemplary motor 180a inputs motion to cause the right side of the exemplary belt 184a to move in the direction referenced by arrow 250 a. As a result, the exemplary gear-pulley 186a will rotate CCW based on the perspective of FIG. 18, the exemplary gear-pulley 188a will rotate CW, the exemplary gears 192a and 196a will rotate CCW, and the exemplary gear 200a will rotate CW.

Continuing the transmission of this motion and referring to FIG. 25, the exemplary gear 204a will rotate CW, the exemplary gear 216a will rotate CCW, and the exemplary gears 220a and 252a will rotate CW. Because the exemplary shuttle 82a is locked, the rotation of the exemplary gears 220a and 252a will drive the track portions 230a and 232a out of the curved track portions in the side plates 86a, 88a. This drives the exemplary latch 222a to its right-side end limit of travel. The exemplary left side 242a of the aperture 238a will then engage the exemplary projection 240a and thereby move the exemplary plate 90a to the right, away from the exemplary plate 92a.

In a subsequent operation, the exemplary latch 222a can be returned to its left-most position, thus bringing the plates 90a, 92a back together. The exemplary shuttle 82a is again maintained at the second position and in the vertical orientation. The lock 244a remains in the locking position. The exemplary latch 222a is initially at its right-most end limit of travel. Referring again to FIG. 18, the exemplary motor 180a inputs motion to cause the left side of the exemplary belt 184a to move in the direction referenced by arrow 256a, which is opposite to the direction represented by arrow 250a. The respective directions of rotation for the gear-pulleys and gears will therefore be opposite as well, relative to the descriptions described immediately above. Because the exemplary shuttle 82a is locked, the rotation of the exemplary gears 220a and 252a will drive the track portions 230a and 232a back into the curved track portions in the side plates 86a, 88a. This drives the exemplary latch 222a to its left-side end limit of travel. The exemplary left side 242a of the aperture 238a eventually separates from engagement with the exemplary projection 240a and thus permits the exemplary plates 90a, 92a to move back together under the biasing forces generated by the exemplary springs 226a, 228a. It is noted that the exemplary plates 90a, 92a may be in contact with one another when “fully” brought back together or may be separated by some predetermined amount when “fully” brought back together in various embodiments of the present disclosure.

In a subsequent operation, the exemplary shuttle 82a can be rotated from the vertical orientation to the horizontal orientation. It is noted that during this movement, the exemplary shuttle 82a is rotating about the central axis of the shaft on which the exemplary gear 208a is mounted for rotation. When the exemplary shuttle 82a is to be rotated, the exemplary lock 244a is first rotated in the direction 246a about the axis 248a, away from the locking position. How the exemplary lock 244a is rotated will be detailed below. Referring again to FIG. 18, after the exemplary lock 244a is moved away from the locking position, the exemplary motor 180a inputs motion to cause the right side of the exemplary belt 184a to move in the direction referenced by arrow 250a. The respective directions of rotation for the gear-pulleys and gears will be as described above when the exemplary belt 184a moves in the direction referenced by arrow 250a. Because the exemplary shuttle 82a is unlocked, the rotation of the exemplary gears 220a and 252a will result in the exemplary gears 220a, 252a moving along the curved track portions 230a and 232a, rather than the gears 220a, 252A imposing motion on the track portions 230a, 232a. This will further result in rotation of the plates 90a, 92a in the CCW direction based on the perspective of FIGS. 29A-29C . It is also noted that rotation of the exemplary shuttle 82a from the vertical orientation to the horizontal orientation results in separation between and disengagement of the gears 204a and 216a.

The exemplary shuttle 82a also includes additional structures that guide movement of the plates 90a, 92a during rotation from the vertical orientation to the horizontal orientation. Referring to FIGS. 21, 24 and 25, a post 258a extends outward from the shaft portion 218a and is received in a slot 260a that is defined by the side plate 86a. The post 258a acts as a follower and moves along the path defined by the slot 260 during the rotation of the exemplary plates 90a, 92a from the vertical orientation to the horizontal orientation.

In a subsequent operation, the exemplary shuttle 82a can be moved from the second rectilinear position to the first rectilinear position while in the horizontal orientation. Referring again to FIG. 18, this is accomplished by the exemplary motor 180a continuing to input motion to cause the right side of the exemplary belt 184a to move in the direction referenced by arrow 250a. Movement of the belt 184a in the direction associated with arrow 250a will also result in movement of a top side of the belt 194a in the direction of arrow 262a because of rotation of the pulley portion of the exemplary gear-pulley 188a. Further, movement of the top side of the belt 194a in the direction of arrow 262a will result in CW rotation (based on the orientation of FIG. 18) of the pulley 206a. Referring now to FIG. 25, further, rotation of the pulley 206a in the CW direction will result in CW rotation (based on the orientation of FIG. 25) of the gear 208a. Further, rotation of the gear 208a in the CW direction will result in CCW rotation (based on the orientation of FIG. 25) of the gear 216a. Further, rotation of the gear 216a in the CCW direction will result in CW rotation (based on the orientation of FIG. 25) of the gear 220a. Teeth of the exemplary gears 220a, 252a will engage with teeth of generally straight track portions 264a and 266a respectively defined by the side plates 86a, 88a and thereby cause movement of the exemplary shuttle 82a from the second rectilinear position to the first rectilinear position.

It is noted that when the exemplary shuttle 82a is locked, the exemplary pulley 206a and exemplary gear 208a are prevented from moving rectilinearly, as occurs when the exemplary shuttle 82a moves between the second rectilinear position and the first rectilinear position. But this prevention of movement does not interfere with movement of the belt 194a because the pulley 206a and gear 208a can still rotate when the exemplary shuttle 82a is locked.

In a subsequent operation, the exemplary shuttle 82a can be moved back to the second rectilinear position from the first rectilinear position while in the horizontal orientation. Referring again to FIG. 18, this is accomplished by the exemplary motor 180a inputting motion to cause the left side of the exemplary belt 184a to move in the direction referenced by arrow 256a. It is noted that a lower portion of the exemplary belt 194a will move in the direction 418a, which correspond to movement of the belt 194a that is opposite to the direction associated with the arrow 262a.

In a subsequent operation, when the exemplary shuttle 82a reaches the second position while in the horizontal orientation, the exemplary shuttle 82a can be rotated to the vertical orientation. This is accomplished by the exemplary motor 180a continuing to input motion to cause the left side of the exemplary belt 184a to move in the direction referenced by arrow 256a. The exemplary lock 244a can be rotated to the locking position when the exemplary shuttle 82a reaches the vertical orientation.

With reference to FIG. 24, the exemplary shuttle assembly 62a also includes an arm 410 mounted on the exemplary side plate 86a for rotation about an axis 412. The exemplary shuttle assembly 62a also includes a spring 414 that biases an end 416 of the exemplary arm 410 against the shaft portion 212a (referenced in FIG. 30). This inhibits the rotation axis of the exemplary shuttle 82a from shifting when the exemplary shuttle 82a is rotating between the vertical and horizontal orientations.

The exemplary pulley 182a, belt 184a, gear-pulley 186a, gear-pulley 188a, double gear 190a, belt 194a, double gear 198a, belt 194a, gear 206a, an gear 208a define an exemplary motion transmission linkage between the exemplary motor 180a and the exemplary gear 220a during one or more periods of operation of the exemplary embodiment. The exemplary pulley 182a, belt 184a, gear-pulley 186a, gear-pulley 188a, double gear 190a, belt 194a, double gear 198a, belt 194a, gear 206a, gear 208a, and latch 222a define an exemplary motion transmission linkage between the exemplary motor 180a and the exemplary gear plate 90a during one or more periods of operation of the exemplary embodiment.

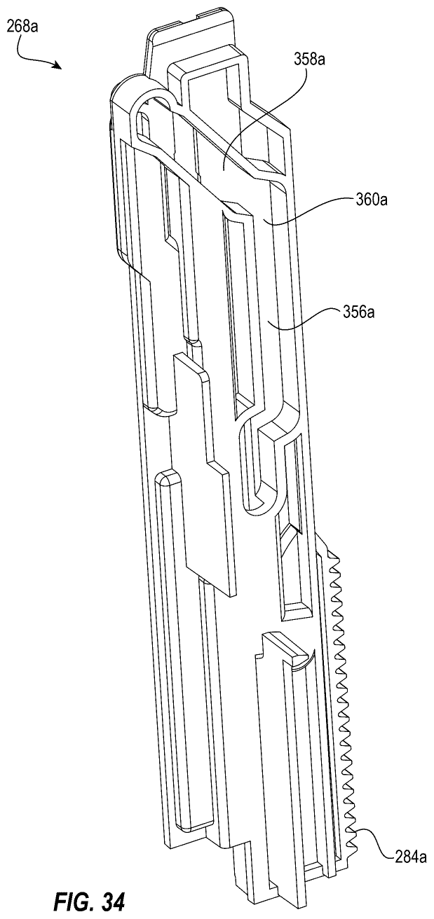

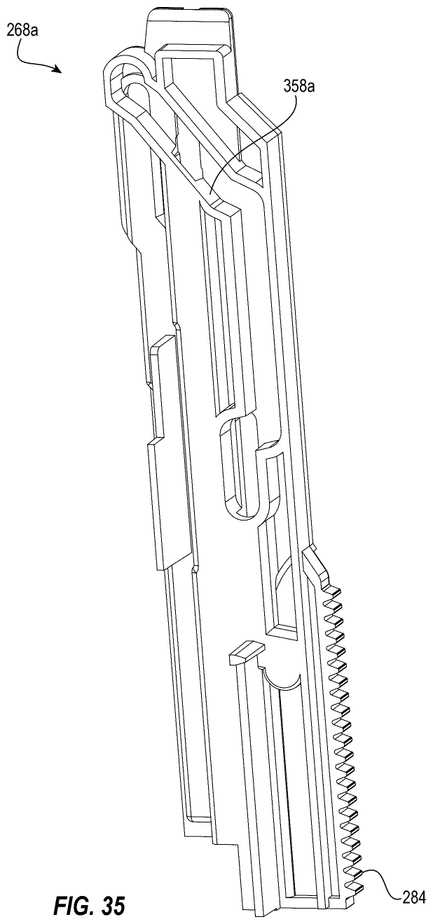

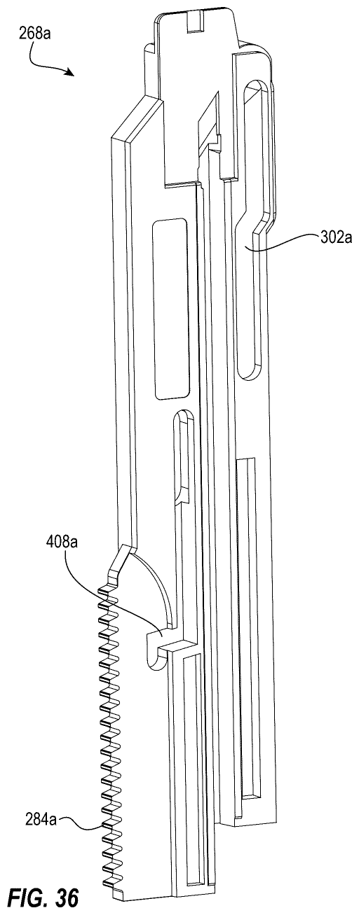

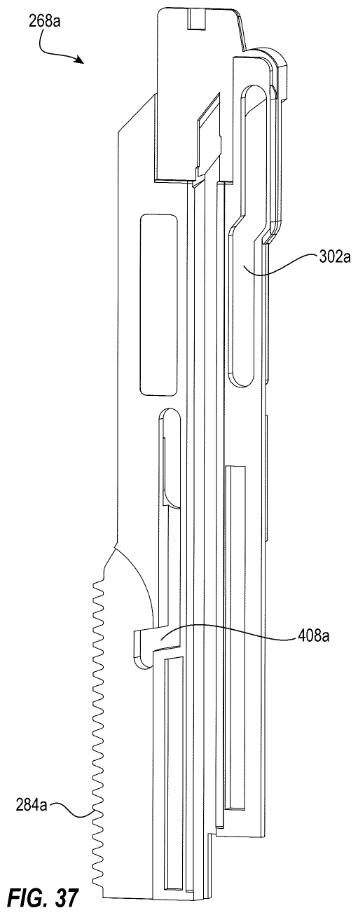

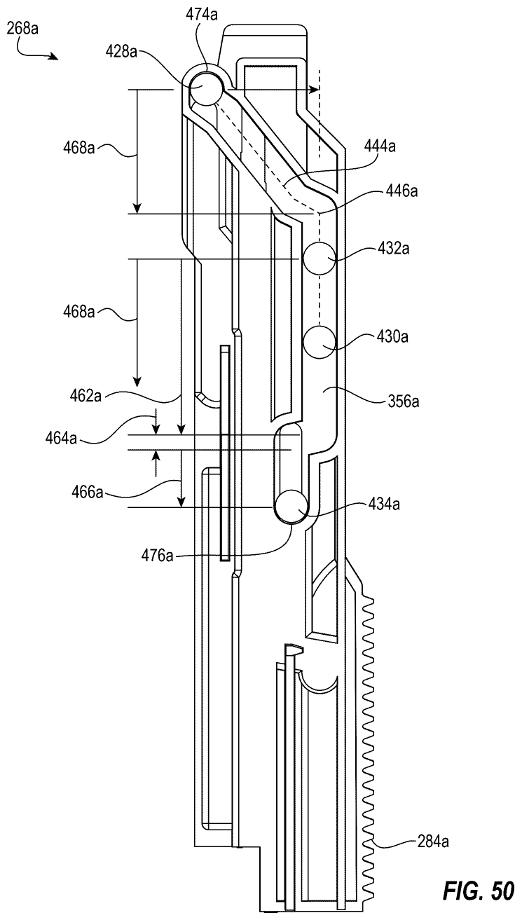

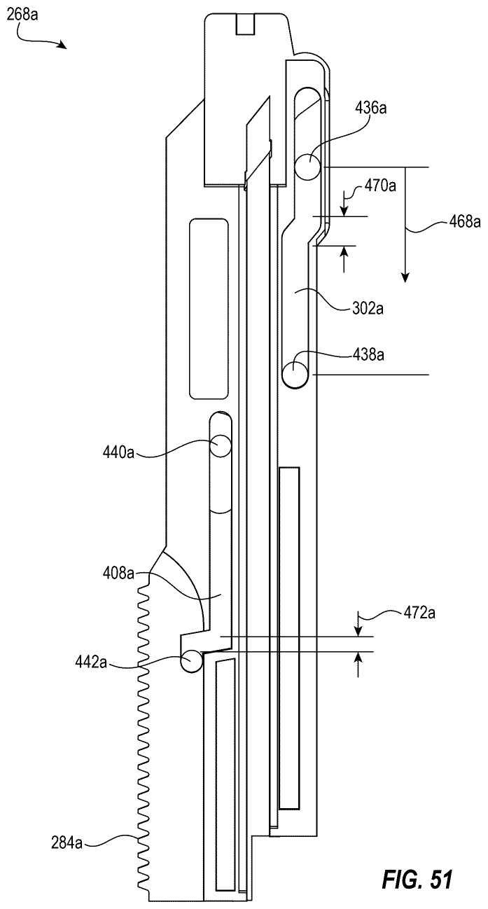

Referring now to FIGS. 12, 34-37, 50, and 51, the exemplary currency transport assembly 40a also includes a cam 268a to transmit motion for the execution of a plurality of different operations. A cover 270a of the exemplary currency transport assembly 40a that is shown in FIG. 3 has been removed in FIG. 12 to show internal structures including the exemplary cam 268a. The exemplary cam 268a is positioned in a space that is defined by the exemplary cover 270a and an exemplary sub-housing 290a. The exemplary cam 268a is moveable between first and second positions. The exemplary cam 268a moves rectilinearly, in a direction between the top and bottom of the exemplary currency transport assembly 40a. A first position can be a “top” end limit of travel and a second position can be a “bottom” end limit of travel. Various perspective views of the exemplary cam 268a are provided in FIGS. 34-27. Orthogonal views of the exemplary cam 268a are provided in FIGS. 50 and 51.

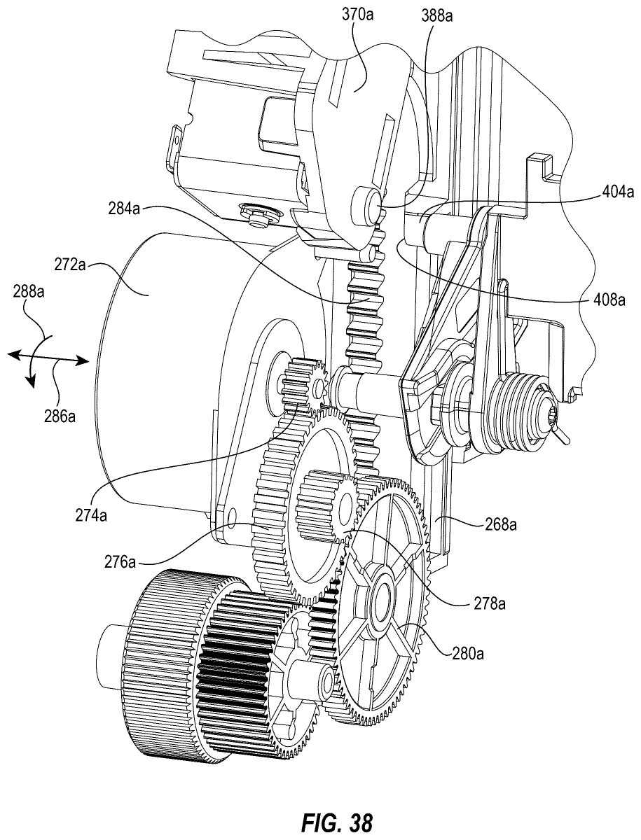

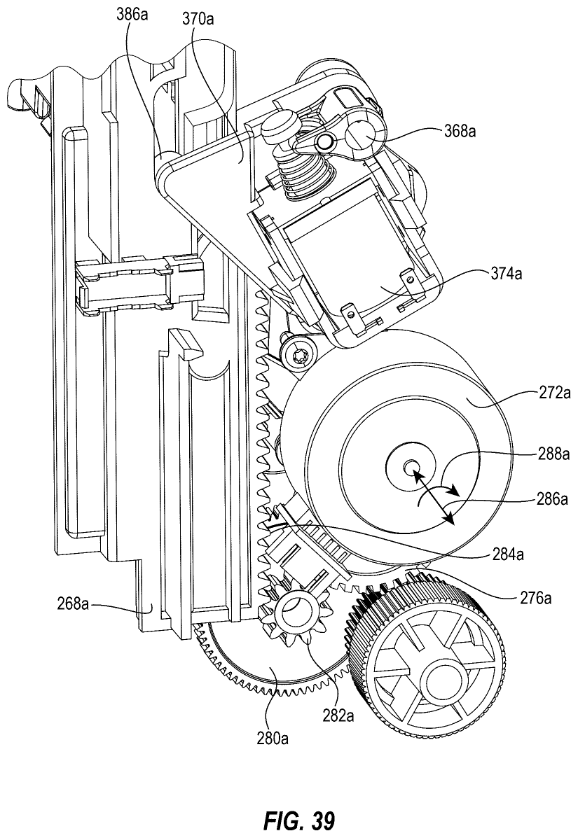

Referring now to FIGS. 12, 38, and 39, the exemplary currency transport assembly 40a also includes a motor 272a to move the cam 268a. In the exemplary embodiment, a shaft of the motor 272a is received in a gear 274a. The exemplary motor 272a can drive the gear 274a in rotation in the CW direction. The operation of the exemplary motor 272a can be reversed so that the exemplary motor 272a can also drive the gear 274a in rotation in the CCW direction. In FIGS. 38 and 39, a central axis of an output shaft of the exemplary motor 272a is referenced at 286a and rotation in the CW direction is referenced at 288a.

Referring again to FIGS. 38 and 39, teeth of the exemplary gear 274a mesh with teeth of a gear 276a the exemplary currency transport assembly 40a. The exemplary gear 276a is integral with a gear 278a of the exemplary currency transport assembly 40a and rotates concurrently with the gear 278a. Teeth of the gear 278a mesh with teeth of a gear 280a of the exemplary currency transport assembly 40a. The exemplary gear 280a is integral and rotates concurrently with a gear 282a of the exemplary currency transport assembly 40a. Teeth of the exemplary gear 282a mesh with teeth 284a defined by the exemplary cam 268a. The meshing relationships among the exemplary gears 274a, 276a, 278a, 280a, 282a and the exemplary teeth 284a results in the exemplary cam 268a moving upward when the exemplary gear 274a is rotated in the CW direction and also in the exemplary cam 268a moving downward when the exemplary gear 274a is rotated in the CCW direction.

In the exemplary embodiment, movement of the exemplary cam 268a in the upward direction, away from a bottom end limit of travel, results in the exemplary lock 244a moving from the unlocked position (shown in FIG. 29A and B) to the locked position (shown in FIG. 29C). Movement of the exemplary cam 268a in the downward direction results in the exemplary lock 244a moving from the locked position to the unlocked position.

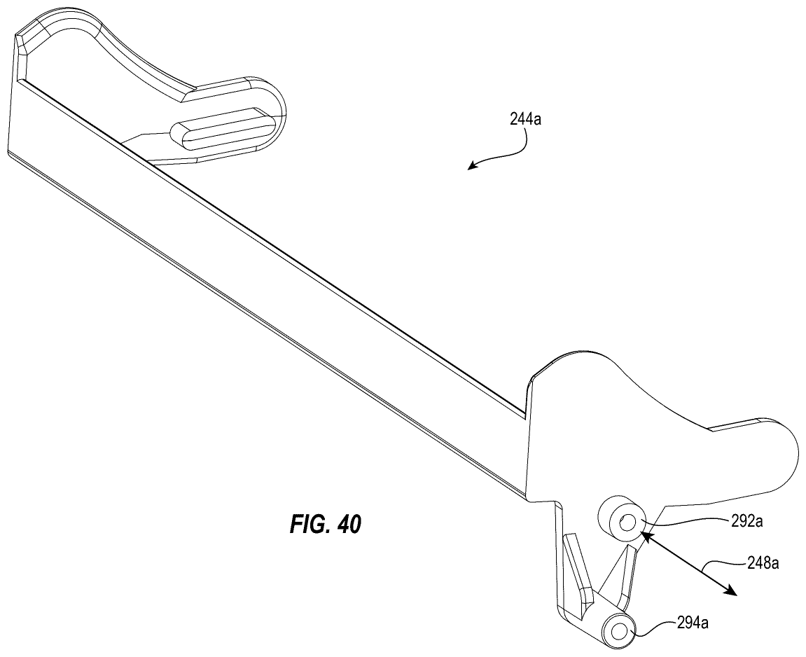

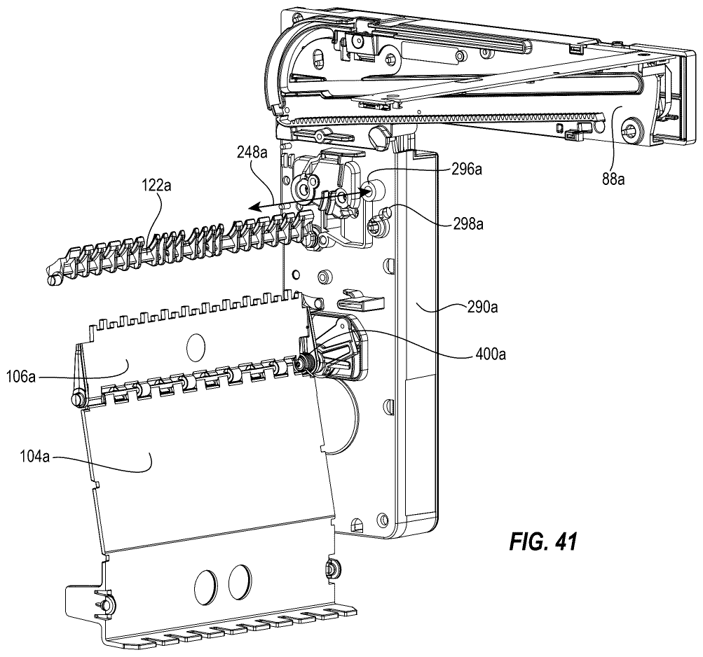

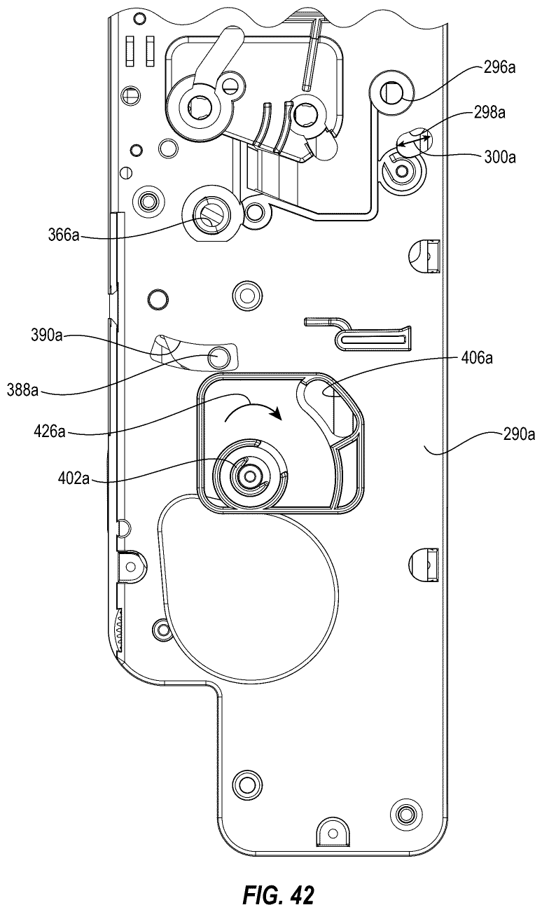

Referring now to FIG. 40, the exemplary lock 244a includes a post 292a and a pin 294a. The exemplary lock 244a rotates/pivots about the exemplary post 292a, which is centered on the axis 248a. Referring now to FIGS. 41 and 42, the exemplary post 292a is mounted in an aperture 296a defined by the exemplary sub-housing 290a and thereby supported for rotating/pivoting movement. The exemplary pin 294a extends through a slot 298a defined by the sub-housing 290a. The exemplary pin 294a and slot 298a are configured such that the exemplary pin 294a moves laterally relative to the exemplary sub-housing 290a within the exemplary slot 298a, the shifting movement along the arrow referenced by 300a in FIG. 42.

The exemplary pin 294a extends through the slot 298a and extends further into a channel 302a that is defined by the exemplary cam 268a. The exemplary slot includes a first portion 304a and a second portion 306a laterally offset with respect to one another. The exemplary channel 302a also includes a transition portion 308a interconnecting the exemplary first portion 304a and the exemplary second portion 306a.

When the exemplary cam 268a is at its bottom end limit of travel, the exemplary pin 294a is positioned in the exemplary second portion 306a of the exemplary channel 302a. This position of the exemplary pin 294a corresponds to the exemplary lock 244a being in the unlocked position. When the exemplary cam 268a is moved upward from its bottom end limit of travel, the exemplary pin 294a is engaged by the exemplary transition portion 308a and acts a cam follower. The exemplary pin 294a is moved laterally by the exemplary transition portion 308a and moved into the exemplary first portion 304a. This movement of the exemplary pin 294a results in rotation of the exemplary lock 244a into the locked position. The exemplary pin 294a thus defines an interconnection linkage between the exemplary cam 268a and the exemplary lock 244a.

In the exemplary embodiment, movement of the exemplary cam 268a in the downward direction from its top end limit of travel toward its bottom end limit of travel of the exemplary cam 268a results in opening of the exemplary shutter 174a. Movement of the exemplary cam 268a in the upward direction from its bottom end limit of travel toward its top end limit of travel results in closing of the exemplary shutter 174a.

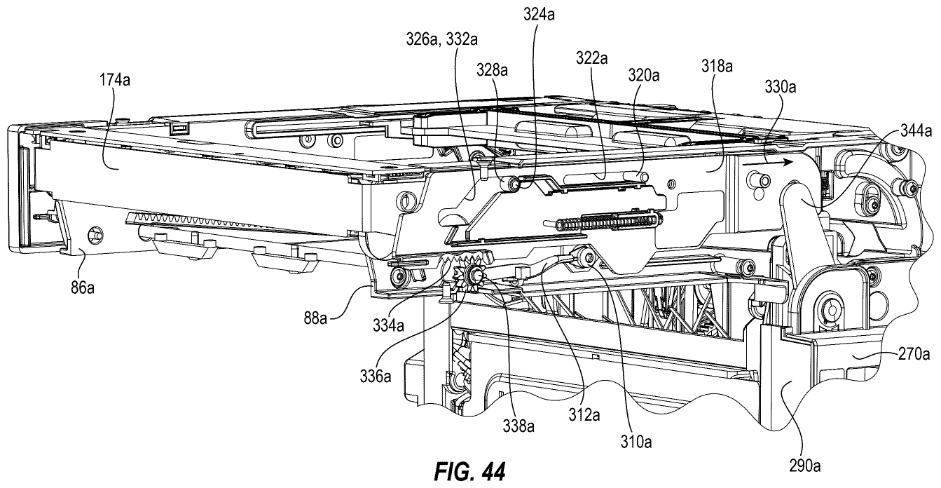

Referring now to FIG. 44, the exemplary shutter 174a is mounted for pivoting movement on a pair of pins. A first of these pins is referenced at 310a. Although not shown, a similar pin supports an opposite side of the exemplary shutter 174a in pivoting movement. The pins, including pin 310a, are located and supported by respective spring arms, such as spring arm 312a that is mounted to an underside of the end cover plate 172a (shown in cross-section in FIG. 18). The exemplary shutter 174a is shown in FIG. 44 in its closed position. As shown in FIG. 18, the exemplary shutter 174a closes an aperture 314a of the end cover plate 172a when in its closed position.

The exemplary shutter 174a is engaged on a first side with a cam plate 316a (referenced in FIG. 18) and is engaged on second side with a cam plate 318a (referenced in FIG. 44). The first side of the exemplary shutter 174a and the exemplary cam plate 316a are positioned between the side plate 86a and the side cover plate 168a. The exemplary cam plate 316a is moveable within the space between the side plate 86a and the side cover plate 168a. The second side of the exemplary shutter 174a and the exemplary cam plate 318a are positioned between the side plate 88a and the side cover plate 170a. The exemplary cam plate 318a is moveable within the space between the side plate 88a and the side cover plate 170a.

Referring again to FIG. 44, a pin 320a is fixedly mounted in the second side of the exemplary shutter 174a and extends through a slot 322a in the cam plate 318a. A second pin 324a is fixedly mounted in the second side of the exemplary shutter 174a and extends through a slot 326a in the cam plate 318a. A roller 328a surrounds the exemplary pin 324a and is operatively positioned between the exemplary pin 324a and the exemplary slot 326a to enhance sliding relative movement between the exemplary pin 324a and the exemplary slot 326a. It is noted that the first side of the exemplary shutter 174a and the cam plate 316a are similarly connected and engaged with one another.

The exemplary shutter 174a is moved away from its closed position, to open the aperture 314a, by movement of the exemplary cam plates 316a, 318a. The exemplary cam plate 318a is shown in FIG. 44 in a first position. Referring again to FIG. 44, the exemplary cam plate 318a can be moved away from its first position in the direction referenced by arrow 330a. When the exemplary cam plate 318a moves in the direction 330a, the exemplary pin 324a and exemplary roller 328a move along the exemplary slot 326a, which includes a downward sloping portion 332a. The engagement of the exemplary pin 324a and the exemplary roller 328a and the exemplary downward sloping portion 332a causes the exemplary shutter 174a to pivot about the exemplary pin 310a and thereby move away from its closed position to its open position whereby the aperture 314a is open.

It is noted that movement of the exemplary cam plate 318a is transmitted to the exemplary cam plate 316a by way of teeth 334a of the exemplary cam plate 318a, a gear 336a with teeth meshed to the exemplary teeth 334a, a shaft 338a fixedly engaged for concurrent rotation with the exemplary gear 336a, a gear 340a (see FIG. 18) fixedly engaged for concurrent rotation with the exemplary 338a, and teeth 342a of the exemplary cam plate 316a meshed with teeth of the exemplary gear 340a. In the exemplary embodiment, the movement of the exemplary cam plate 318a is transmitted to, and results in identical motion of, the exemplary cam plate 316a. Further, movement of the first and second sides of the exemplary shutter 174a is identical.

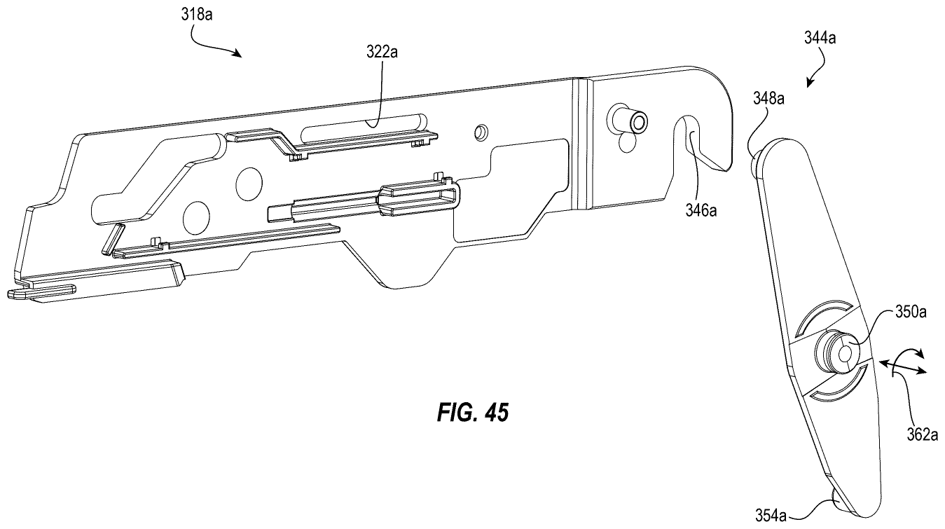

The exemplary cam plate 318a is moved in the direction 330a with a lever arm 344a. Referring now to FIGS. 44 and 45, the exemplary cam plate 318a includes a notch 346a and the exemplary lever arm 344a includes a post 348a received in the exemplary notch 346a. The exemplary lever arm 344a also includes a post 350a. The exemplary post 350a is received in an aperture 352a defined by the exemplary cover 270a, best shown in FIG. 3. The exemplary lever arm 344a is pivotally/rotationally mounted to exemplary cover 270a through the interconnection between the exemplary post 350a and the exemplary aperture 352a.

The exemplary lever arm 344a also includes a pin 354a. The exemplary pin 354a is positioned in a channel 356a (referenced in FIG. 34) of the exemplary cam 268a. The exemplary pin 354a moves within a sloped portion 358a of the exemplary channel 356a and acts as a cam follower. When the exemplary cam 268a is at its top end limit of travel, the exemplary pin 354a is positioned in a vertical portion 360a (referenced in FIG. 34) of the channel 356a. When the exemplary cam 268a is moved downward from its top end limit of travel, the exemplary pin 354a is urged laterally away from the vertical portion 360a. This causes the exemplary lever arm 344a to rotate about the exemplary post 350a in the direction referenced at 362a in FIG. 45. Further, the engagement between the post 348a and notch 346a, as the exemplary post 348a is rotating about the exemplary post 350a in the direction 362a, causes the exemplary cam plate 318a to move in the direction 330a referenced in FIG. 44. The exemplary cam plate 318a, the exemplary lever arm 344a, and the exemplary pin 354a, at least, thus define an interconnection linkage between the exemplary cam 268a and the exemplary shutter 174a.

In the exemplary embodiment, movement of the exemplary cam 268a in the downward direction from its top end limit of travel results in movement of the exemplary gate 122a from its third position to its second position. Movement of the exemplary cam 268a in the upward direction from its bottom end limit of travel results in movement of the exemplary gate 122a from its second position to its third position.

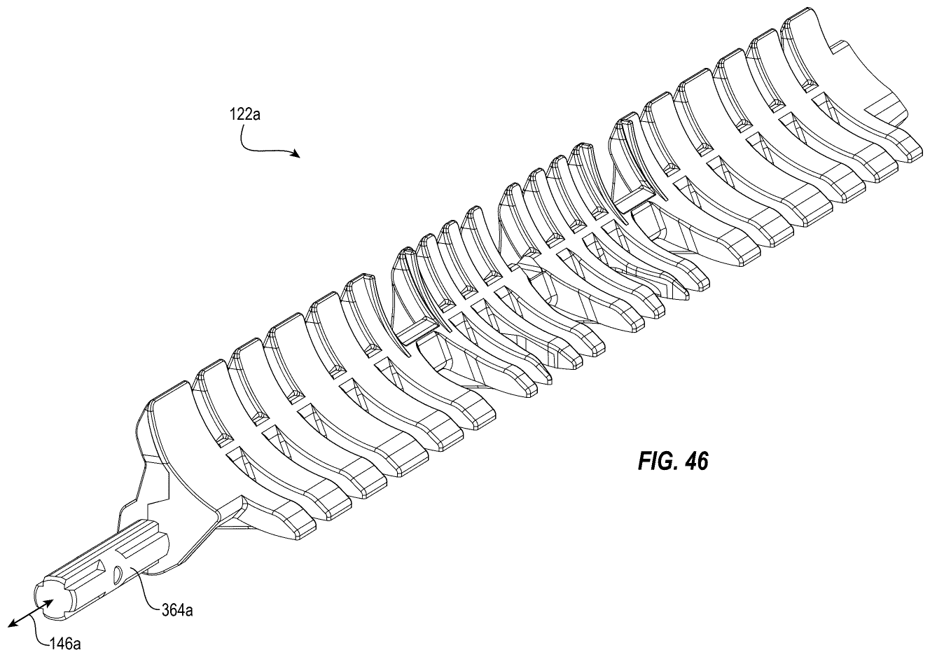

The operations of the exemplary gate 122a are disclosed above and opposite end limits of pivoting/rotational travel of the exemplary gate 122a are shown in FIGS. 9 and 10. Referring now to FIG. 46, the exemplary gate 122a is mounted for pivoting movement through a pair of posts. One of these posts is referenced at 364a (shown with cross sectional plane) and the other post is mirrored relative to the exemplary post 364a and extends from an opposite side of the exemplary gate 122a. The exemplary post 364a is received in and support for pivoting movement in an aperture 366a (referenced in FIG. 42) in the exemplary sub-housing 290a. The post of the exemplary gate 122a that is opposite to the exemplary post 364a is received in an aperture of a structure on the front side of the exemplary currency conveyor 40a.

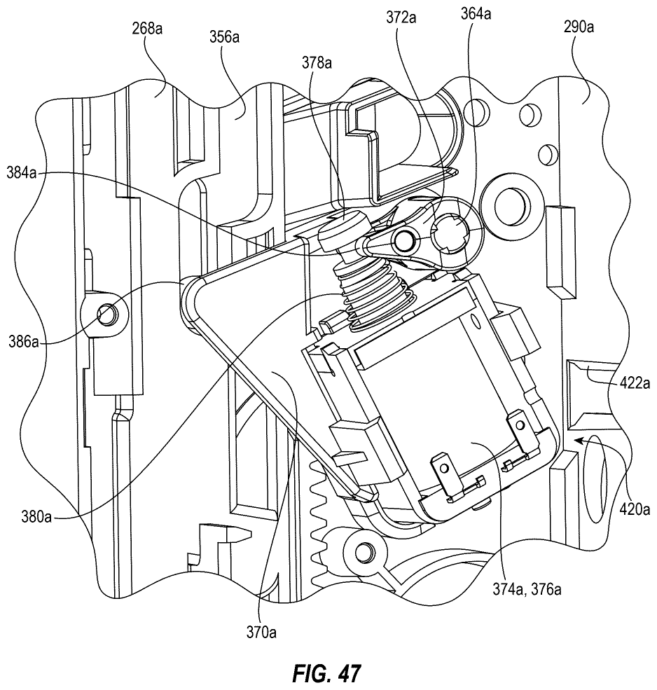

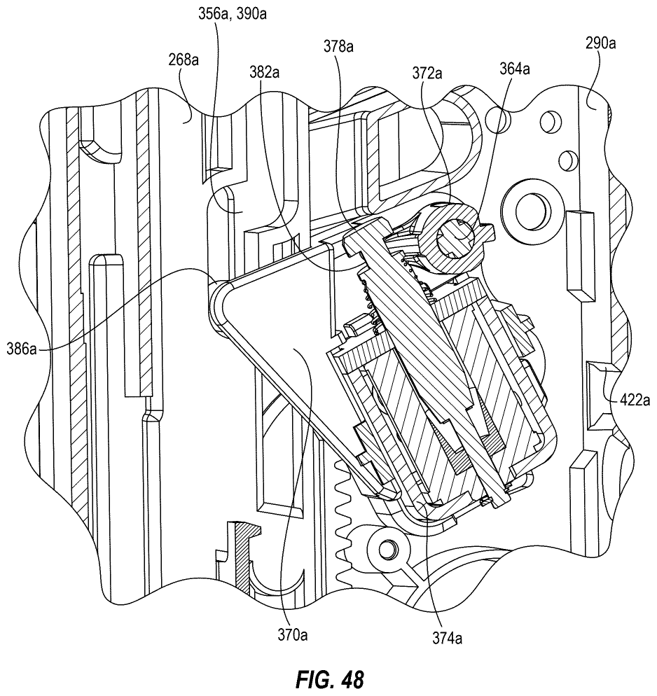

Referring now to FIGS. 47 and 48, the exemplary currency transport assembly 40a also includes the following components that play a role in movement of the exemplary gate 122a: a plate 370a, a yoke 372a, and a solenoid 374a. The exemplary plate 370a is mounted for pivoting movement on the exemplary sub-housing 290a. The exemplary plate 370a and the exemplary gate 122a pivot about the same pivot axis 146a but can rotate relative to one another.

The exemplary yoke 372a is fixed to the exemplary post 368a for concurrent pivoting movement. The exemplary solenoid 374a includes a body 376a, a plunger 378a, and a spring 380a. The exemplary body 376a is fixedly mounted on the exemplary plate 370a for joint movement. The exemplary plunger 378a is selectively extendable out of the exemplary body 376a when the exemplary solenoid 374a is energized and retractable into the exemplary body 376a when the exemplary solenoid 374a is de-energized. The exemplary spring 380a biases the exemplary plunger 378a to project out of the exemplary body 376a when the exemplary solenoid 374a is de-energized.

The exemplary yoke 372a includes first and second arms with a cross bar 384a between the arms that is received in a neck portion 382a of the exemplary plunger 378a. This arrangement allows the exemplary yoke 372a and exemplary plunger 378a to pivot relative to one another while still engaged such that extension and retraction of the exemplary plunger 378a will cause rotation of the exemplary yoke 372a and thus rotation of the exemplary gate 122a.

The exemplary plate 370a includes a pin 386a positioned in the channel 356a of the exemplary cam 268a. In FIGS. 47 and 48, the exemplary cam 268a is shown in its top end limit of travel. When the exemplary cam 268a is moved downward, the exemplary pin 386a acts as a cam follower in the exemplary channel 356a. A transition portion 390a of the exemplary channel 356a engages the exemplary pin 386a during downward movement of the exemplary cam 268a from its top end limit of travel. The exemplary transition portion 390a urges the exemplary pin 386a to the right based on the perspectives of FIGS. 47 and 48. Movement of the exemplary pin 386a to the right results in rotation of the exemplary plate 370a in the CCW direction based on the perspective of FIGS. 47 and 48. FIGS. 47 and 48 show the exemplary plate 370a (and thus also the solenoid 374a) at CW end limit of travel. When the exemplary cam 268a moves downward and the exemplary transition portion 390a urges the exemplary pin 386a to the right, the exemplary plate 370a moves to its CCW end limit of travel at which a corner 420a of the exemplary plate 370a is received in a gap 422a defined in the exemplary sub-housing 290a.

As shown in FIG. 42, the exemplary plate 370a also includes a pin 388a positioned in a slot 390a defined by the exemplary sub-housing 290a. The cooperation/engagement between the exemplary pin 388a and the exemplary slot 390a enhance the control over pivoting movement of the exemplary plate 370a.

The respective positions of components in FIGS. 47 and 48 correspond to the exemplary gate 122a being in the position shown in FIG. 10, referred to above as its third position. The exemplary gate 122a is so positioned for stack retract and dump (shingled feeding) to direct currency notes down to the exemplary volume/portion 100a. The exemplary plate 370a is at its CW end limit of travel. The exemplary solenoid 374a is not energized.

The second position of the exemplary gate 122a is shown in FIG. 8. When the exemplary gate 122a is to be moved from its third position to its second position, the exemplary cam 268a can be moved in the downward direction from its top end limit of travel. Because of engagement between the exemplary pin 386a and the channel 356a, the downward movement of the exemplary cam 268a results in CCW rotation of the exemplary plate 370a to its CCW end limit of travel. Further, because of the engagement between the exemplary plunger 378a and the exemplary cross bar 384a, rotation of the exemplary plate 370a to its CCW end limit of travel results in rotation of the exemplary gate 122a from its third position to its second position.

The first position of the exemplary gate 122a is shown in FIG. 9. When the exemplary gate 122a is to be moved from its second position to its first position, the exemplary plate 370a is already in its CCW end limit of travel. The exemplary solenoid 374a is then energized. This results in the exemplary plunger 378a being drawn into the body 376a against the biasing force of the exemplary spring 380a. This, in turn, results in an application of force on the cross bar 384a by the exemplary plunger 378a, which induces rotation of the exemplary yoke 372a and exemplary gate 122a in the CCW direction based on the perspective of FIGS. 47 and 48.

The plate 370a, the solenoid 374a, and the yoke 372a, at least, define an interconnection linkage between the exemplary cam 268a and the exemplary gate 122a, with the pin 386a being the cam follower in direct contact with the exemplary cam 268a.

In the exemplary embodiment, movement of the exemplary cam 268a in the downward direction from its top end limit of travel of the exemplary cam 268a results in movement of the exemplary gate 106a from the position shown in FIG. 10 to the position shown in FIG. 9. Movement of the exemplary cam 268a in the upward direction results in movement of the exemplary gate 106a from the position shown in FIG. 9 to the position shown in FIG. 10.

As shown by FIGS. 9 and 10, the exemplary gate 106a is mounted to the exemplary partition 104a for pivoting movement about the exemplary pivot axis 138a. FIG. 9 shows the exemplary gate 106a at its CCW end limit of travel. When the exemplary gate 106a is at its CCW end limit of travel, currency notes can be directed to the exemplary volume/portion 102a. FIG. 10 shows the exemplary gate 106a at its CW end limit of travel. When the exemplary gate 106a is at its CW end limit of travel, currency notes can be directed to the exemplary volume/portion 100a.

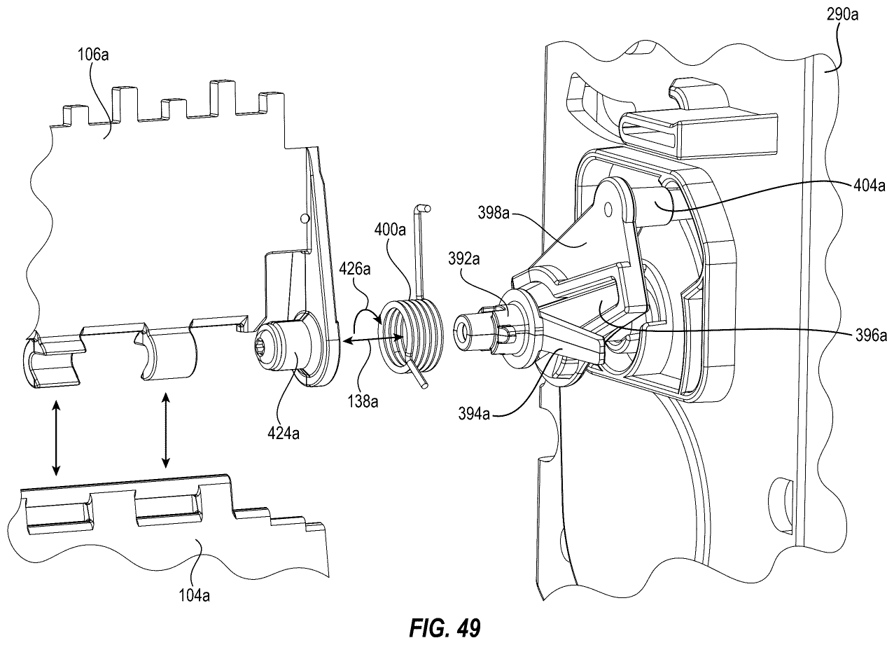

Referring now to FIG. 49, the exemplary gate 106a is fixedly interconnected to a hub 392a for concurrent rotation. The exemplary hub 392a includes an arm 394a. The exemplary hub 392a is received in a depression 396a of a pivot 398a. A shape of the depression 396a corresponds to a profile of the exemplary hub 392a whereby the exemplary hub 392a and the exemplary pivot 398a are fixed together for concurrent rotation.

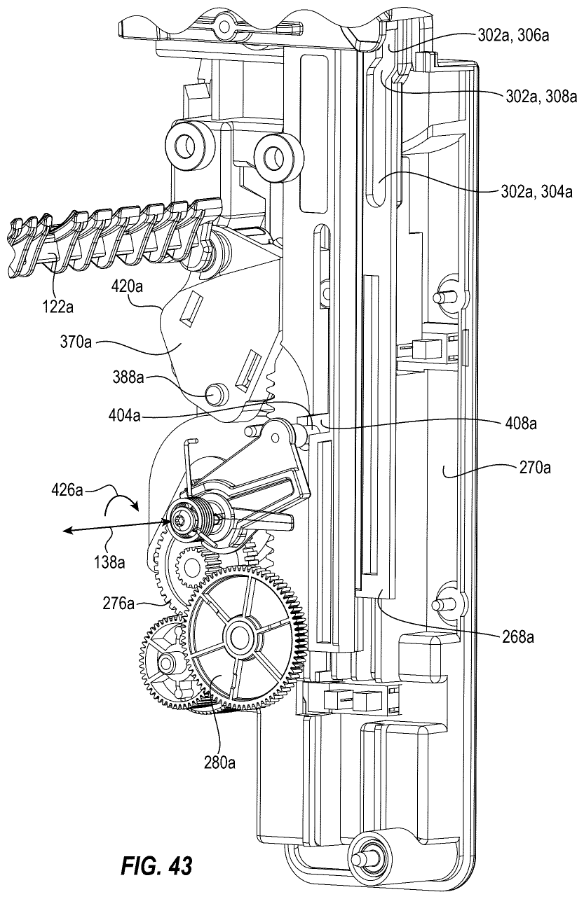

The exemplary pivot 398a is mounted for pivoting movement in a cylindrical mount 402a (referenced in FIG. 42) defined by the exemplary sub-housing 290a about the axis 138a. The exemplary pivot 398a also includes a pin 404a that extends through a slot 406a (referenced in FIG. 42) defined by the exemplary sub-housing 290a and further extends into a channel 408a (referenced in FIG. 43) of the exemplary cam 268a. A spring 400a is mounted on a post 424a of the exemplary gate 106a and is operably positioned between the exemplary gate 106a and the exemplary partition 104a to bias the exemplary gate 106a to its CCW end limit of travel, the position shown in FIG. 9. The direction of biasing is referenced at 426a in FIGS. 10, 42, 43, and 49.

FIG. 9 corresponds to conditions when the exemplary cam 268a is at its bottom end limit of travel and FIG. 10 corresponds to conditions when the exemplary cam 268a is at its top end limit of travel. When the exemplary cam 268a is moved downward from its top end limit of travel, the exemplary pin 404a acts as a cam follower and is moved by the surface of the exemplary slot 406a and also by the surfaces of the exemplary channel 408a. As the exemplary cam 268a moves downward, the exemplary pin 404a moves, the gate 106a moves from the position shown in FIG. 10 to the position shown in FIG. 9. The hub 392a and pivot 398a, at least, thus define an interconnection linkage between the exemplary cam 268a and the exemplary gate 106a, with the pin 404a acting as the cam follower directly in contact with the exemplary cam 268a.

FIG. 50 is a substantially orthogonal (non-perspective) front view of the exemplary cam 268a. The circle 428a represents the position of the exemplary pin 354a within the channel 356a when the exemplary shutter 174a is in its open position. This position of the exemplary pin 354a also corresponds to the exemplary cam 268a being at its bottom end limit of travel or at least closer to its bottom end limit of travel than its top end limit of travel.

The circle 430a represents the position of the exemplary pin 354a within the channel 356a when the exemplary shutter 174a is in its closed position. This position of the exemplary pin 354a also corresponds to the exemplary cam 268a being at its top end limit of travel or at least closer to its top end limit of travel than its bottom end limit of travel.

The circle 432a represents the position of the exemplary pin 386a within the channel 356a when the exemplary plate 370a is at its CCW end limit of travel. This position of the exemplary pin 386a also corresponds to the exemplary cam 268a being at its bottom end limit of travel or at least closer to its bottom end limit of travel than its top end limit of travel.

The circle 434a represents the position of the exemplary pin 386a within the channel 356a when the exemplary plate 370a is at its CW end limit of travel. This position of the exemplary pin 386a also corresponds to the exemplary cam 268a being at its top end limit of travel or at least closer to its top end limit of travel than its bottom end limit of travel.

FIG. 51 is a substantially orthogonal (non-perspective) rear view of the exemplary cam 268a. The circle 436a represents the position of the exemplary pin 294a within the channel 302a when the exemplary lock 244a is in the unlocked position. This position of the exemplary pin 294a also corresponds to the exemplary cam 268a being at its bottom end limit of travel or at least closer to its bottom end limit of travel than its top end limit of travel.

The circle 438a represents the position of the exemplary pin 294a within the channel 302a when the exemplary lock 244a is in the locked position. This position of the exemplary pin 294a also corresponds to the exemplary cam 268a being at its top end limit of travel or at least closer to its top end limit of travel than its bottom end limit of travel.

The circle 440a represents the position of the exemplary pin 404a within the channel 408a when the exemplary gate 106a is at its CCW end limit of travel, as shown in FIG. 10. This position of the exemplary pin 404a also corresponds to the exemplary cam 268a being at its bottom end limit of travel or at least closer to its bottom end limit of travel than its top end limit of travel. This position of the exemplary pin 404a also corresponds to the exemplary pin 404a being at the bottom and right of the slot 406a based on the perspective of FIG. 42. This position of the exemplary pin 404a also corresponds to spring 400a being at a minimum deformation.

The circle 442a represents the position of the exemplary pin 404a within the channel 408a when the exemplary gate 106a is at its CW end limit of travel, as shown in FIG. 9. This position of the exemplary pin 404a also corresponds to the exemplary cam 268a is at its top end limit of travel or at least closer to its top end limit of travel than its bottom end limit of travel. This position of the exemplary pin 404a also corresponds to the pin 404a being at the top and left of the slot 406a based on the perspective of FIG. 42. This position of the exemplary pin 404a also corresponds to the spring 400a being at a maximum deformation.

As shown by FIGS. 50 and 51, the exemplary cam 268a provides channels that permit the transmission of motion along a plurality of parallel motion pathways concurrently. The exemplary channels 302a, 356a, and 408a have sufficient lengths to permit one or more cam followers to remain stationary in a particular position while the exemplary cam 268a moves upwardly or downwardly in order to effectuate movement of one or more other cam followers.

As disclosed above, the exemplary pin 354a takes a plurality of different positions within the exemplary channel 356a as the exemplary cam 268a moves and these positions include those marked by circles 428a and 430a as well as all positions in between the circles 428a and 430a. This portion of a length of the exemplary channel 356a is marked by a dash line 444a. The exemplary pin 354a acts as a cam follower and moves (resulting in rotation/pivoting of the exemplary lever arm 344a) only between the circle 428a and a location 446a along the length of the dash line 444a. The exemplary pin 354a is stationary at positions along the length of the dash line 444a between the location 446a and the circle 430a; the exemplary pin 354a only changes positions along the length of the dash line 444a between the location 446a and the circle 430a because the exemplary cam 268a is moving. The movement of the exemplary cam 268a when a position of the exemplary pin 354a is along the length of the dash line 444a between the location 446a and the circle 430a is thus lost motion. During this period, while the exemplary pin 354a is stationary, another one or more of the cam followers (the exemplary pin 294a, the exemplary pin 404a, or the exemplary pin 386a) can be moved by another channel of the exemplary cam 268a.

As disclosed above, with reference to FIGS. 24 and 25, the exemplary shuttle assembly 62a includes an exemplary first track 450a. The exemplary first track 450a includes the straight track portion 264a and the arcuate/deformable track portion 230a. The exemplary first track 450a extends between a first track end 452a (the gear 220a is shown at the first track end 452a) and a second track end 454a. The second track end 454a of the exemplary first track 450a corresponds to the exemplary distal end 89a. The exemplary shuttle 82a is configured to move rectilinearly and rotationally along the exemplary first track 450a between the first track end 452a and the second track end 454a. The exemplary shuttle 82a moves rectilinearly along the exemplary straight track portion 264a. The exemplary shuttle 82a moves rotationally along the exemplary the arcuate/deformable track portion 230a. The exemplary gear 220a is the portion of the exemplary shuttle assembly 62a that directly engages the exemplary first track 450a. A motion transmission linkage is defined in the present disclosure that interconnects the exemplary output shaft 181a to the exemplary gear 206a of the exemplary shuttle 82a to move the exemplary shuttle 82a along the exemplary first track 450a between the first track end 452a and the second track end 454a. This motion transmission linkage also partially interconnects the exemplary output shaft 181a to the exemplary latch 222a to selectively move the exemplary latch 222a from the first position to the second position. The exemplary motion transmission linkage provides a constant and continuous connection and is defined by exemplary pulley 182a, belt 184a, gear-pulley 186a, gear-pulley 188a, double gear 190a, belt 194a, double gear 198a, and the belt 194a.

As disclosed above, the exemplary shuttle 82a further comprises at least one motion transmission member mounted on one of the exemplary first plate 90a and the exemplary second plate 92a. This at least one motion transmission member can selectively interconnect the motion transmission linkage to the exemplary latch 222a to selectively move the exemplary latch 222a from the first position to the second position. In the exemplary embodiment, the exemplary shuttle 82a includes motion transmission members in the form of any of exemplary gears 206a, 208a mounted on the exemplary plate 92a and the motion transmission linkage is defined by the exemplary pulley 182a, belt 184a, gear-pulley 186a, gear-pulley 188a, and double gear 198a.

As disclosed above, the at least one motion transmission member can be further defined as at least one gear mounted for rotation on the one of the exemplary first plate 90a and the exemplary second plate 92a, such as any of exemplary gears 206a, 208a.

As disclosed above, the at least one motion transmission member moves into and out of engagement with the exemplary latch 222a as the exemplary shuttle 82a moves along the exemplary first track 450a, such as the gear 220a.

As disclosed above, the at least one motion transmission member can move into engagement with the exemplary latch 222a when the exemplary shuttle 82a moves into the first track end 452a of the exemplary first track 450a and moves out of engagement with the exemplary latch 222a when the exemplary shuttle 82a moves away from the first track end 452a of the exemplary first track 450a, such as the exemplary gear 220a.

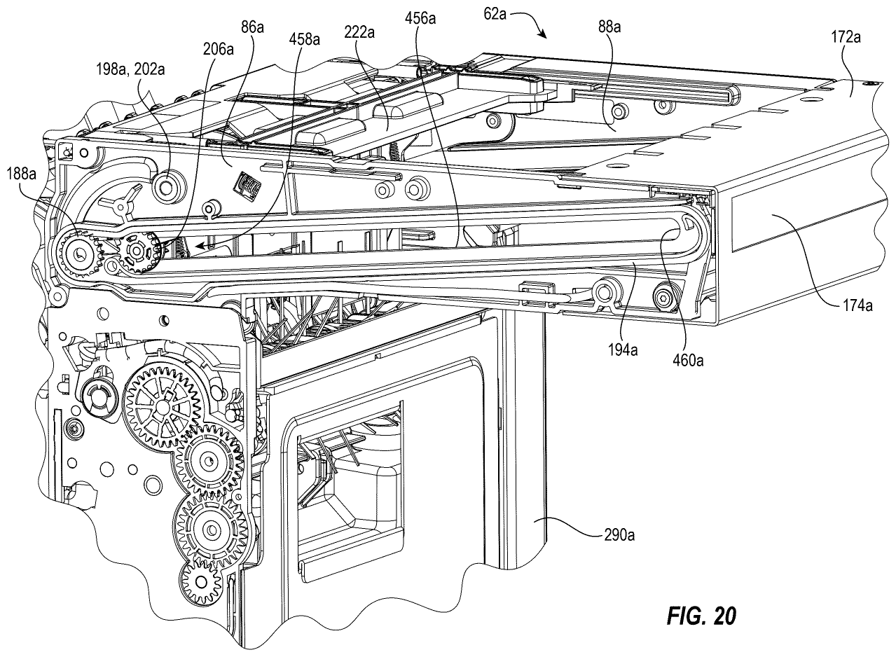

As disclosed above, with reference to FIG. 20, the exemplary shuttle assembly 62a includes an exemplary second track 456a extending between a first track end 458a (“retracted”track end, exemplary shuttle 82a rotated or not rotated, FIGS. 25 and 29A-29C) and a second track end 460a. The exemplary gear 206a is shown at the exemplary first track end 458a and the exemplary second track end 460a corresponds to the distal end 89a. The exemplary second track 456a spaced from the exemplary first track 450a. The exemplary second track 456a is smooth slot and the shaft portion 210a of the exemplary gear 208a is received in the exemplary second track 456a. The exemplary shuttle 82a is further defined as configured to move rectilinearly along the exemplary second track 456a between the first track end of the exemplary second track 456a and the second track end the exemplary second track 456a at least partially while moving between the first track end of the exemplary first track 450a and the second track end the exemplary first track 450a. The exemplary shaft portion 210a can define an axis of rotation of the exemplary shuttle 82a when the exemplary shuttle 82a is at the exemplary first track end 458a.

As disclosed above, one of the exemplary first track 450a and the exemplary second track 456a includes teeth and the other of the exemplary first track 450a and the exemplary second track 456a does not include teeth.

As disclosed above, the exemplary first track 450a is shaped to induce rectilinear movement, by the exemplary straight portion 264a, and rotational movement, by the arcuate portion 230a, of the exemplary shuttle 82a as the exemplary shuttle 82a moves along the exemplary first track 450a between the first track end 452a of the exemplary first track 450a and the second track end 454a of the exemplary first track 450a. The exemplary second track 456a is shaped to induce rectilinear movement of the exemplary shuttle 82a as the exemplary shuttle 82a moves along the exemplary second track 456a between the first track end 458a of the exemplary second track 456a and the second track end 460a of the exemplary second track 456a.

As disclosed above, the exemplary first track 450a is includes a first portion in the form of the arcuate portion 230a that induces rotation of the exemplary shuttle 82a between a first angular orientation and a second angular orientation. The exemplary second track 456a fixes an axis of rotation of the exemplary shuttle 82a, the centerline axis of the shaft portion 210a during rotation of the exemplary shuttle 82a between the first angular orientation and the second angular orientation.

As disclosed above, the exemplary first track 450a includes a second portion, in the form of the portion 264a, that induces rectilinear movement of the exemplary shuttle 82a.

As disclosed above, the exemplary first track 450a includes a first portion, in the form of portion 230a, that is moveable and a second portion, in the form of portion 264a, that is fixed. The first portion of the exemplary first track 450a moveable between a first position and a second position. Biasing devices in the form of springs 226, 228 are positioned to bias the first portion of the exemplary first track 450a to the first position.

As disclosed above, at least part of the exemplary first track 450a, in the form of portion 230a, is elastically deformed during movement of the exemplary latch 222a from the first position of the exemplary latch 222a and the second position of the exemplary latch 222a.

As disclosed above, 14. The currency transport assembly 40a of claim 13 wherein the at least part of the exemplary first track 450a in the form of the portion 230a and the exemplary latch 222a are integrally formed with respect to one another.

As disclosed above, the currency transport assembly 40a includes the lock 244a that is moveable to and from an engagement position. FIG. 29c shows the lock 244a in the engagement position. The exemplary lock 244a prevents the exemplary plate 92a from moving when the lock 244a is in the engagement position. The exemplary shuttle 82a is moveable when the lock 244a is spaced from the engagement position.

As disclosed above, a motion transmission linkage includes the exemplary belt 194a. The exemplary shuttle 82a includes a first post 448a (referenced in FIG. 22) extending from the exemplary plate 92a, the exemplary gears 206a, 208a mounted for rotation on the first post 448a and driven in rotation by the belt 194a, a second shaft 254a extending from the exemplary plate 92a, the gear 220a mounted for rotation on the second shaft 254a and meshed with the exemplary gear 208a. The exemplary gear 220a is engaged with the exemplary first track 450a and the engagement between the exemplary gear 220a and the exemplary first track 450a results in movement of the exemplary shuttle 82a along the exemplary first track 450a.

As disclosed above, a motion transmission linkage includes a first sub-linkage extending from the exemplary output shaft 181a to a first member (defined by gear-pulley 188) of the motion transmission linkage; the exemplary first sub-linkage includes the exemplary pulley 182a, belt 184a, and gear-pulley 186a. The motion transmission linkage also includes a second sub-linkage extending from the first member to a second member (defined by the double gear 198) of the motion transmission linkage mounted on the exemplary shuttle 82a; the exemplary second sub-linkage includes the double gear 190. The motion transmission linkage also includes a third sub-linkage extending from the first member to a third member in the form of gear 206a mounted on the exemplary shuttle 82a member; the exemplary third sub-linkage includes the exemplary belt 194a. The third sub-linkage extends in parallel to the second sub-linkage between the first member and different locations on the exemplary shuttle 82a. The second member of the motion transmission linkage and the third member of the motion transmission linkage are concurrently driven in motion whenever the motor is running.

As disclosed above, a method of transporting currency notes includes moving currency notes between an interior of an automated transaction machine 10 to an outlet of the automated transaction machine 10, such as the slot 28, with an exemplary shuttle assembly 62a having an exemplary first track 450a extending between a first track end 452a and a second track end 454a and an exemplary shuttle 82a configured to move along the exemplary first track 450a between the first track end 452a and the second track end 454a wherein the exemplary shuttle 82a has an exemplary first plate 90a and a exemplary second plate 92a interconnected to one another between which the currency notes are held. The exemplary first plate 90a and the exemplary second plate 92a configured to move toward and away from one another. The method also includes moving the exemplary shuttle 82a along with the exemplary first track 450a with the motor 180a having the exemplary output shaft 181a configured to selectively rotate in clockwise and counter-clockwise directions and interconnected to the exemplary shuttle 82a through a motion transmission linkage. The method also includes selectively moving one of the exemplary first plate 90a and the exemplary second plate 92a away from the other with the exemplary latch 222a that is driven in motion by the motor and at least part of the motion transmission linkage that drives the exemplary shuttle 82a in motion.

As disclosed above, the method can also include switching the transmission of motion from the moving the exemplary shuttle 82a to the selectively moving the one of the exemplary first plate 90a and the exemplary second plate 92a by locking the other of the exemplary first plate 90a and the exemplary second plate 92a with a lock. In the exemplary embodiment, the plate 92a is locked and the plate 90a is moved. Locking of the plate 92a prevents movement of the entire shuttle 80a.

As disclosed above, the method can also include switching the transmission of motion from the moving the exemplary shuttle 82a to the selectively moving the one of the exemplary first plate 90a and the exemplary second plate 92a by changing the direction of rotation of the exemplary output shaft 181a. In the exemplary embodiment, the shaft 181a rotates in one direction in moving the shuttle 82a to the first position 452a from the second position 454a. When the gear 220a of the shuttle 82a reaches the first position 452a, and the lock 244a is engaged to lock the plate 92a, the direction of rotation of the shaft 181a is reversed and the latch 244a moves the plate 90a away from the plate 92a.

As disclosed above, the exemplary currency transport assembly 40a includes the exemplary gate 122a and the exemplary gate 122a is moveable between a plurality of positions. At each position, the exemplary gate 122a directs currency notes to one of a first plurality of different pathways. For example, the exemplary gate 122a directs currency notes along a first path that extends away from the exemplary gate 122a to the exemplary cassette 96a when the exemplary gate 122a is in a first position (shown in FIG. 9). In another example, the exemplary gate 122a directs currency notes along a second path that extends away from the exemplary gate 122a to the exemplary shuttle 82a when the exemplary gate 122a is in a second position (shown in FIG. 8).

The exemplary currency transport assembly 40a also includes the exemplary gate 106a. The exemplary gate 106a is spaced from the exemplary gate 122a along the first path described above. The exemplary gate 106a is also moveable between a plurality of positions. The exemplary gate 106a directs currency notes to one of a second plurality of different pathways. For example, the exemplary gate 106a directs currency notes along a first path that extends away from the exemplary gate 106a to the exemplary first portion 100a of the interior of cassette 96a when the exemplary gate 106a is in a first position (shown in FIG. 6). In another example, the exemplary gate 106a directs currency notes along a second path that extends away from the exemplary gate 106a to the exemplary first portion 100a of the interior of cassette 96a when the exemplary gate 106a is in a second position (shown in FIG. 5).

The exemplary currency transport assembly 40a also includes the exemplary cam 268a that is operably and concurrently engaged with the exemplary gate 122a and with the exemplary gate 106a. Motion of the exemplary cam 268a is transmitted to the exemplary gate 122a over at least a first portion of a range of movement of the exemplary cam 268a and motion of the exemplary cam 268a is transmitted to the exemplary gate 106a over at least a second portion of the range of movement of the exemplary cam 268a. In the exemplary embodiment, the exemplary cam 268a is engaged to the exemplary gate 122a through the exemplary channel 356a, the exemplary post 364a and exemplary plate 370a, and the exemplary solenoid 374a. In the exemplary embodiment, the exemplary cam 268a is engaged to the exemplary gate 106a through the exemplary channel 408a and the exemplary pin 404a and exemplary pivot 398a.

As set forth above, FIGS. 50 and 51 show front and back (opposite) sides of the exemplary cam 268a and show the various positions of pins when the exemplary cam 268a is at a top/upper end limit of travel and at a bottom/lower end limit of travel. Movement between the top/upper end limit of travel and the bottom/lower end limit of travel is the range of movement of the exemplary cam 268a.

As set forth above, motion of the exemplary cam 268a is transmitted to the exemplary gate 122a over at least a first portion of a range of movement of the exemplary cam 268a. The range of movement of the exemplary cam 268a relative to the pin 386a associated with the gate 122a is represented in FIG. 50 by arrows 462a, 464a, and 466a. The circle 432a represents the position of the exemplary pin 386a within the channel 356a when the exemplary cam 268a is at its bottom/lower end limit of travel and the circle 434a represents the position of the exemplary pin 386a within the channel 356a when the exemplary cam 268a is at its top/upper end limit of travel. When the exemplary cam 268a moves from its bottom/lower end limit of travel, the arrow 462a represents an initial period or portion of the motion of the exemplary cam 268a. During this portion of movement, the exemplary pin 386a does not move while the exemplary cam 268a moves; this portion of movement is thus lost motion between the exemplary cam 268a and the exemplary pin 386a. As the exemplary cam 268a continues to move from its bottom/lower end limit of travel, the arrows 464a represent the first portion of the motion of the exemplary cam 268a referenced above, during which motion is transmitted. As the exemplary cam 268a continues to move from its bottom/lower end limit of travel, the arrow 466a represents the last portion of the motion of the exemplary cam 268a when moving from its bottom/lower end limit of travel to its top/upper end limit of travel. During this last portion of movement, the exemplary pin 386a does not move while the exemplary cam 268a moves; this portion of movement is thus lost motion between the exemplary cam 268a and the exemplary pin 386a.

With continuing reference to FIG. 50, the circle 428a represents the position of the exemplary pin 354a within the channel 356a when the exemplary cam 268a is at its bottom/lower end limit of travel and the circle 430a represents the position of the exemplary pin 354a within the channel 356a when the exemplary cam 268a is at its top/upper end limit of travel. The arrow 468a represents another period or portion of the motion of the exemplary cam 268a. During this portion of movement, the exemplary pin 354a moves while the exemplary cam 268a moves. The arrow 468a is shown a second time in FIG. 50, next to the arrow 462a, to compare the respective portions of the range movement over which movement is transmitted to the pins 354a and 386a. The respective portions of the range movement over which motion is transmitted to the pins 354a and 386a are distinct. In other words, the portion associated with movement of the pin 354a occurs while the pin 386a is not being moved and the portion associated with movement of the pin 386a occurs while the pin 354a is not being moved.

With reference to FIG. 51, the circle 436a represents the position of the exemplary pin 294a within the channel 302a when the exemplary cam 268a is at its bottom/lower end limit of travel and the circle 438a represents the position of the exemplary pin 294a within the channel 302a when the exemplary cam 268a is at its top/upper end limit of travel. The portion of the range of movement of the exemplary cam 268a during which motion is transmitted to the exemplary pin 294a is referenced by arrows 470a. The arrow 468a is also shown in FIG. 51, next to the arrows 470a, to compare the respective portions of the range movement over which movement is transmitted to the pins 354a and 294a. The respective portions of the range movement over which motion is transmitted to the pins 354a and 294a partially overlap one another. In other words, the portion associated with movement of the pin 354a occurs while the pin 294a is being moved and also before and after the pin 294a is being moved. A portion of the range of movement of the exemplary cam 268a in which motion is transmitted to the exemplary pin 404a is referenced in FIG. 51 at arrows 472a.

It is noted that when the exemplary cam 268a is at its top/upper end limit of travel the teeth of gear 282a would be meshed with the bottom-most of the teeth 284a and when the exemplary cam 268a is at its bottom/lower end limit of travel the teeth of gear 282a would be meshed with the top-most of the teeth 284a.

As disclosed above, the exemplary gate 122a is positioned between the exemplary shuttle 82a and the exemplary cassette 96a, relative at least to the flow of currency notes through the currency transport assembly 40. The exemplary gate 122a is also positioned between the exemplary shuttle 82a and currency cassettes positioned in the rack 66a. The exemplary gate 122a is moveable by the exemplary cam 268a to a first position of the plurality of positions whereby currency notes are directed to a first pathway of a first plurality of different pathways from the exemplary gate 122a to the exemplary cassette 96a as shown in FIG. 9. Such notes can be reject notes and can have traveled to the gate 122a from a cassette positioned in the exemplary rack 66a. The exemplary gate 122a is also moveable by the exemplary cam 268a to a second position of the plurality of positions whereby currency notes are directed to a second pathway of the first plurality of different pathways from the exemplary gate 122a to the exemplary shuttle 82a and shown in FIG. 8. Such notes can be in the process of being dispensed to an account holder and can have traveled to the gate 122a from a cassette positioned in the exemplary rack 66a. The exemplary gate 122a is also moveable by the exemplary cam 268a to a third position of the plurality of positions whereby currency notes are directed to a third pathway of the first plurality of different pathways from the exemplary gate 122a to the exemplary cassette 96a as shown in FIG. 10. Such notes can be reject notes and can have traveled to the gate 122a from the exemplary shuttle 82a.

As disclosed above, the exemplary cam 268a comprises a plurality of exemplary channels 302a, 356a, 408a. Each of the plurality of exemplary channels 302a, 356a, 408a receives at least one of a plurality of exemplary pins 294a, 354a, 386a, 404a. Each pin of the plurality of exemplary pins 294a, 354a, 386a, 404a is one of directly and indirectly engaged with one of the exemplary gate 122a, the exemplary gate 106a, the exemplary lock 244a, and the exemplary shutter 174a. The exemplary cam 268a is thus operably and concurrently engaged with the exemplary gate 122a, the exemplary gate 106a, the exemplary lock 244a, and the exemplary shutter 174a whereby motion of the exemplary cam 268a is transmitted to the exemplary gate 122a, the exemplary gate 106a, the exemplary lock 244a, and the exemplary shutter 174a over respective portions of the overall range of movement of the exemplary cam 268a. At least one of the plurality of exemplary channels 302a, 356a, 408a can receive more than one of the plurality of exemplary pins 294a, 354a, 386a, 404a. In the exemplary embodiment, the exemplary channel 356a receives the exemplary pins 354a and 386a. Motion is transmitted between the exemplary cam 268a and the exemplary gate 122a, the exemplary gate 106a, the exemplary shutter 174a, and the exemplary lock 244a through engagement between the plurality of exemplary channels 302a, 356a, 408a and the plurality of exemplary pins 294a, 354a, 386a, 404a.

The exemplar channel 356a is positioned on a first side of the exemplary cam 268a and the exemplary channels 302a and 408a are positioned on a second side of the exemplary cam 268a opposite to the first side of the exemplary cam 268a.

Referring again to FIG. 50, the exemplary channel 356a extends a first distance between a first end 474a and a second end 476a. The first distance can be defined along a line that is centered in the exemplary channel 356a, terminating at the ends 474a, 476a. The exemplary dash line 444a overlaps a portion of the first distance and the exemplary location 446a is on the line defining the first distance. The exemplary first distance extends further along, past the length of the dash line 444a.

As shown by the exemplary first distance, a distance defined by a channel in one or more exemplary embodiments of the present disclosure may not fully rectilinear (straight). A distance defined by a channel in one or more exemplary embodiments of the present disclosure may have portions that are rectilinear and others that are arcuate, or may be fully rectilinear, or fully arcuate with one or more different radii.

As set forth above, when the exemplary cam 268a begins to move upward from its bottom/lowermost position, the exemplary pin 354a is located at the circle 428a. As the exemplary cam 268a begins to moves upward, the position that the exemplary pin 354a occupies within the exemplary channel 356a changes; the first position represented by the exemplary circle 428a and the final position represented by the exemplary circle 430a. The exemplary pin 354a is moving laterally and not along the exemplary channel 356a. Once the exemplary pin 354a reaches the exemplary location 446a, the exemplary pin 354a no longer moves and the exemplary cam 268a is moving without moving the exemplary pin 354a; the exemplary pin 354a thus becomes an “observer” as the exemplary cam 268a moves by. This is lost motion as between the exemplary cam 268a and the exemplary pin 354a; during this period of operation the exemplary cam 268a is moving but not producing work on the exemplary pin 354a. Thus, a second distance, between the circles 428a, 430a along the length of the exemplary channel 356a, is less than the first distance. As shown by FIGS. 50 and 51, lost motion is defined between all of the exemplary slots and exemplary pins. This structural feature of the exemplary channels and pins permits the driving of multiple elements at different times and different amounts with a single cam.

As disclosed above, the exemplary currency transport assembly 40a includes a moving device engaged with the exemplary cam 268a to move the exemplary cam 268a over the range of movement of the exemplary cam 268a between a first end limit of travel and a second end limit of travel. The moving device in the exemplary embodiment is the exemplary motor 272a. As disclosed above, the exemplary gear 282a is driven in rotation by the exemplary motor 272a and is meshed with the exemplary plurality of teeth 284a defined by the exemplary cam 268a.

As disclosed above, the exemplary plate 370a interposed between the exemplary cam 268a and the exemplary gate 122a wherein motion transmitted during the at least first portion of the range of movement of the exemplary cam 268a, represented by arrows 464a, is transmitted to the exemplary gate 122a through the exemplary plate 370a. The exemplary cam 268a and the exemplary plate 370a are engaged with one another such that the exemplary plate 370a pivots in response to movement of the exemplary cam 268a over the at least first portion of the range of movement of the exemplary cam 268a. The exemplary solenoid 374a is interposed between the exemplary cam 268a and the exemplary gate 122a wherein motion transmitted during the at least first portion of the range of movement of the exemplary cam 268a is transmitted to the exemplary gate 122a through the exemplary solenoid 374a.

The exemplary solenoid 374a is mounted on the exemplary plate 370a and pivots with the exemplary plate 370a in response to movement of the exemplary cam 268a over at least the first portion of the range of movement. The exemplary solenoid 374a produces further movement of the exemplary gate 122a when energized. The exemplary solenoid 374a thus provides motion that is additional/cumulative to the motion of the exemplary cam 268a and the exemplary plate 370a. The extension of the exemplary plunger 378a is motion that is transmitted to gate 122a and produces rotational motion of the gate 122a; this extends rotation of the gate 122a beyond the rotation that results from movement of the exemplary cam 268a and the exemplary plate 370a.

The present disclosure provides a method of transporting currency notes. The method includes directing notes of currency along a plurality of different paths among a plurality of currency cassettes and an outlet. By way of example and not limitation, in the exemplary embodiment, a transport path of currency notes is defined between the cassettes in the rack 66a and the gate 122a, another between the gate 122a and the gate 106a, another between the gate 122a and the exemplary shuttle 82a. The method also includes driving respective motions of a plurality of note effectors positioned along the plurality of different paths with an exemplary cam 268a. “Effectors” move one or more notes of currency, such a belts or wheels, or direct the movement of currency notes. The exemplary embodiment includes effectors in the form of gate 122a, gate 106a, exemplary shuttle 82a, and exemplary lock 244a. The method also includes driving the exemplary cam 268a with the exemplary motor 272a.
Example 1: A currency transport assembly can include the exemplary shuttle assembly 62a, the exemplary latch 222a, the exemplary motor 180a, and an exemplary motion transmission linkage which can include one or more of the components referenced by 182a, 184a, 186a, 188a, 190a, 194a, 198a, 206a, 208a. The exemplary shuttle assembly 62a can include the exemplary first track 450a and the exemplary shuttle 82a. The exemplary first track 450a can extend between the first track end 452a and the second track end 454a. The exemplary shuttle 82a can be configured to move along the exemplary first track 450a between the first track end 452a and the second track end 454a. The exemplary shuttle 82a has the exemplary first plate 90a and the exemplary second plate 92a interconnected to one another. The exemplary first plate 90a and the exemplary second plate 92a are configured to move toward and away from one another. The exemplary latch 222a is moveable between a first position to a second position, wherein during movement from the first position to the second position the exemplary latch 222a engages at least one of the exemplary first plate 90a and the exemplary second plate 92a and thereby moves the at least one of the exemplary first plate 90a and the exemplary second plate 92a away from the other the exemplary first plate 90a and the exemplary second plate 92a. The exemplary motor 180a has an output shaft 181a configured to selectively rotate in clockwise and counter-clockwise directions. The motion transmission linkage including one or more of the exemplary components 182a, 184a, 186a, 188a, 190a, 194a, 198a, 206a, 208a interconnects the exemplary output shaft 181a to the exemplary shuttle 82a to move the exemplary shuttle 82a along the first track 450a between the first track end 452a and the second track end 454a and also partially interconnecting the exemplary output shaft 181a to the exemplary latch 222a to selectively move the exemplary latch 222a from the first position to the second position.
Example 2: The exemplary shuttle assembly 62 a also includes the exemplary second track 456a. The exemplary second track 456a extends between the first track end 458 and the second track end 460a. The exemplary second track 456a is spaced from the first track 450a. The exemplary shuttle 82a is configured to move along the exemplary second track 456a between the first track end 458 of the exemplary second track 456a and the second track end 460a of the exemplary second track 456a during at least part of movement of the exemplary shuttle 82a along the first track 450a between the first track end 452a of the first track 450a and the second track end 454a of the first track 450a. The exemplary first and second tracks 450a, 456a guide rectilinear movement of the exemplary shuttle 82a and also cooperate to hold the pivot axis of the exemplary shuttle 82a during its rotation.
Example 3: The currency transport assembly of claim 2 wherein the exemplary first track 450a includes the first portion that is arcuate and the second portion that is straight. The first portion of the exemplary first track 450a induces rotation of the exemplary shuttle 82a between a first angular orientation and a second angular orientation when the exemplary shuttle 82a is moving along the first portion of the exemplary first track 450a. The exemplary second track 456a inhibits movement of the axis of rotation of the exemplary shuttle 82a during the rotation of the exemplary shuttle 82a between the first angular orientation and the second angular orientation. The dual tracks 450a, 456a are helpful in keeping the exemplary shuttle 82a held in place as the exemplary shuttle 82a rotates. FIG. 24 shows this well.
Example 4: The exemplary first portion 230 a that includes the first track end 452 a and is moveable relative to the exemplary motor 180a between a first position and a second position. The exemplary second portion 264a includes the second track end 454a of the exemplary first track 450a and is fixed relative to the exemplary motor 180a.
Example 5: The exemplary shuttle 82 a is guided in movement by the exemplary first portion of the first track 450a when the first portion of the exemplary first track 450a is at the first position. At least one of the exemplary first plate 90a and the exemplary second plate 92a is stationary when the first portion of the exemplary first track 450a is moving from the first position to the second position.
Example 6: With reference to Example 5, the other of the exemplary first plate 90 a and the exemplary second plate 92a is moving when the first portion of the exemplary first track 450a is moving from the first position to the second position.
Example 7: The exemplary latch 222 a can be further defined as being fixed on the first portion of the exemplary first track 450a.
Example 8: In one or more embodiments of the present disclosure, the motion transmission linkage can include the exemplary first member 188a spaced from the exemplary output shaft 181a of the exemplary motor 180a. An exemplary motion transmission linkage can also include a first sub-linkage defined by the components referenced with numbers 182a, 184a, 186a and can extend from the exemplary output shaft 181a of the first exemplary motor 180a to the first member 188a and can transmit rotation of the exemplary output shaft 181a to the exemplay first member 188a that results in motion of the exemplary first member 188a. It is noted that a “sub-linkage” can include a single component or multiple components. An exemplary motion transmission linkage can also include a second member that can be defined by the combination of the exemplary components referenced by numbers 206a and 208a, which are spaced from the exemplary output shaft 181a of the exemplary motor 180a. An exemplary motion transmission linkage can also include a second sub-linkage defined by the exemplary component 194a that extends from the exemplary first member 188a to the exemplary second member 206a, 208a and can transmit motion of the first member 188a to the second member 206a, 208a that results in motion of the second member 206a, 208a. An exemplary motion transmission linkage can also include a third member defined by the component referenced by number 198a that is spaced the exemplary output shaft 181a of the exemplary motor 180a and the second member 206a, 208a. An exemplary motion transmission linkage can also include a third sub-linkage defined by the component referenced with number 190a that extends from the first member 188a to the third member 198a and can transmit motion of the first member 188a to the third member 198a that results in motion of the third member 198a. The second member 206a, 208a is mounted on the exemplary shuttle 82a for rotation relative to the exemplary shuttle 82a and the third member 198a intermittently engages the exemplary shuttle 82a. The exemplary embodiments show rotational power directed to two different gears that engage the exemplary shuttle 82a.
Example 9: The exemplary shuttle 82 a includes the first gear 216 a mounted on one of the exemplary first plate 90a and the exemplary second plate 92a for rotation relative to the one of the exemplary first plate 90a and the exemplary second plate 92a. With reference to Example 8, the second member includes the exemplary gear 208a that is continuously meshed with the exemplary first gear 216a and during movement of the exemplary shuttle 82a along the exemplary first track 450a between the first track end 452a and the second track end 454a. The exemplary first gear 216a is spaced from the exemplary first track 450a during movement of the exemplary shuttle 82a along the exemplary first track 450a between the first track end 452a and the second track end 454a.
Example 10: The currency transport assembly of claim 9 wherein the exemplary first gear 216a engages the third member only when the exemplary shuttle 82a is at one of the first track end 452a and the second track end 454a and not when the exemplary shuttle 82a is along the exemplary first track 450a between the first track end 452a and the second track end 454a. Thus, when the shuttle 82a is being rotated, the gear 216a will receive rotational input through two gears 204a and 208a.
Example 11: The exemplary shuttle 82 a includes the exemplary third gear 220 a that is mounted on the one of the exemplary first plate 90a and the exemplary second plate 92a for rotation relative to the one of the exemplary first plate 90a and the exemplary second plate 92a. The exemplary third gear 220a and the component 208a of the second member are continuously meshed during movement of the exemplary shuttle 82a along the exemplary first track 450a between the first track end 452a and the second track end 454a. The exemplary third gear 220a meshes with the exemplary first track 450a throughout movement of the exemplary shuttle 82a along the exemplary first track 450a between the first track end 452a and the second track end 454a. The exemplary third gear 220a is the gear that moves the shuttle along the exemplary track 450a and also moves the arcuate portion of the track 450a to separate the plates 90a, 92a.
Example 12: The second member 206a, 208a referenced in the Examples above is further defined as including at least the gear 206a and the second sub-linkage is further defined as including at least the belt 194 extending around at least part of the gear 206a whereby movement of the second sub-linkage rotates the second member. The use of the gear 206a and the belt 194a allows motion to be continuously transmitted from the motor 180a to the shuttle 82a even though the distance between the two is changing.
Example 13: The exemplary currency transport assembly includes the lock 244a and the cam 268a. The exemplary lock 244a is movable between a locking position and an unlocked position, wherein the lock 244a prevents movement of the exemplary shuttle 82a when in the locking position and does not prevent movement of the exemplary shuttle 82a when in the unlocked position. The exemplary cam 268a is moveable and engaged with the exemplary lock 244a whereby the lock 244a moves as a cam follower between the locking position and the unlocked position.
Example 14: The exemplary currency transport assembly also includes the exemplary first gate 106a, the exemplary second gate 122a, and the exemplary shutter 174a. The exemplary first gate 106a is moveable between a first position and a second position. The first gate 106a directs a movement of currency notes to a first path when the first gate 106a is in the first position and directs a movement of currency notes to a second path when the first gate 106a is in the second position. The exemplary second gate 122a spaced from the first gate 106a and that is moveable between a first position and a second position and a third position, wherein the second gate 122a directs a movement of currency notes to a third path when the second gate 122a is in the first position of the second gate 122a and directs a movement of currency notes to a fourth path when the second gate 122a is in the second position of the second gate and directs a movement of currency notes to a fifth path when the second gate 122a is in the third position of the second gate. The exemplary shutter 174a is spaced from the first gate 106a and spaced from the second gate 122a. The exemplary shutter 174a is moveable between a first position and a second position, wherein the first gate 106a and the second gate 122a and the shutter are all driven in motion by the cam 268a. Thus, the exemplary cam 268a moves the lock 244a that locks the shuttle 82a, moves the gate 106a that directs bills to either the reject bill space or the retract bill space, moves the gate 122a that directs the movement of bills between the exemplary shuttle 82a and the primary cassettes and the reject/retract cassette, and moves the exemplary shutter 174a at the input/output port.
Example 15: The exemplary currency transport assembly also includes the plate 370 a and the solenoid 374a. The exemplary plate 370a is pivotally moveable between a first position and a second position. The exemplary plate 370a is engaged with the exemplary cam 268a whereby movement of the exemplary cam 268a produces pivoting movement of the exemplary plate 370a. The exemplary plate 370a is disposed between the exemplary cam 268a and the second gate such that pivoting movement of the exemplary plate 370a produces pivoting movement of the second gate 122a. The exemplary solenoid 374a has the body 376a and the plunger 378a. The exemplary plunger 378a is moveable between an extended position relative to the exemplary body 376a and a retracted position relative to the exemplary body 376a. The exemplary solenoid 374a is mounted on the exemplary plate 370a and moves with the exemplary plate 370a during pivoting movement of the exemplary plate 370a. The exemplary solenoid 374a is disposed between the exemplary plate 370a and the exemplary second gate 122a whereby movement of the exemplary plunger 378a between the extended position and the retracted position is superimposed over pivoting movement of the exemplary plate 370a to move the second gate 122a among the first position of the second gate and the second position of the second gate and the third position of the second gate. It is noted that “disposed between” s used above refers to a sequential chain of structures in the transmission of movement. The exemplary cam 268a engages exemplary plate 370a, the exemplary plate 370a then engages exemplary solenoid 374a, and the exemplary solenoid 374a the engages the exemplary gate 122a. “Superimposed” as used above refers to motion that is layered or overlapping. The exemplary plate 370a pivots which causes motion of the second gate 112a and retraction and extension of the exemplary solenoid 374a mounted on the exemplary plate 370a also causes motion of the second gate 122a. In various embodiments, the exemplary solenoid 374a could be set up to extend the range of movement permitted by the pivoting of the exemplary plate 370a. For example, pivoting of the exemplary plate 370a might move the second gate between first and second positions and the exemplary solenoid 374a could be used to move the gate to a third position that is beyond the first and second positions. Alternatively, the pivoting movement of the exemplary plate 370a could define first and second end limits of travel and the exemplary solenoid 374a could be arranged to move the gate away from one of those end limits. For example, the pivoting of the exemplary plate 370a might move the second gate to the first end limit of travel and the exemplary solenoid 374a could then be used to move the gate away from the first end limit to a third position that is in between the first and second end limits.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventor and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. The currency transport assembly disclosed herein incorporates a plurality of distinct and patentable sub-components, sub-systems, and sub-assemblies, each being subject matter of a distinct divisional patent application and the Applicant hereby expressly reserves the right to seek such divisional patent application(s) when the patentability of such sub-components, sub-systems, and sub-assemblies becomes apparent. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventor also asserts that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. A method of transporting currency notes comprising:
moving a stack of currency notes into engagement with a belt;
removing at least a first note and a second note from the stack in a shingled arrangement; and
directing the at least first and second notes into a currency cassette while maintaining the shingled arrangement.

2. The method of claim 1 further comprising:
directing a second stack of currency notes into the currency cassette individually and not in a shingled arrangement.

3. The method of claim 1 wherein said moving further comprises:
bringing first and second plates together on opposite sides of the stack of currency notes; and
positioning a flat portion of a surface area of the belt in a plane between the first and second plates.

4. The method of claim 3 wherein said removing further comprises:
engaging the flat portion of the surface area of the belt directly with a first currency note of the stack of currency notes; and
rotating the belt.

5. The method of claim 3 further comprising:
pressing a portion of a first side of the stack of currency notes against the flat portion of the surface area of the belt during said removing.

6. The method of claim 5 further comprising:
leaving exposed a remainder of the first side of the stack of currency notes other than the portion between the first and second plates.

7. A currency transport assembly comprising:
a shuttle having:
a first plate defining a first surface,
a second plate defining a second surface that confronts said first surface, said second plate further comprising a notch, and
wherein said shuttle is moveable and a first plurality of currency notes is positionable in a stacked arrangement between said first plate and said second plate;
a belt having a surface area including a flat portion that confronts said first surface and is at least partially positioned in said notch.

8. The currency transport assembly of claim 7 wherein said flat portion of said surface area of said belt is positioned in a plane between said first plate and said second plate.

9. The currency transport assembly of claim 8 said plane is further defined as closer to said first plate than said second plate.

10. The currency transport assembly of claim 7 further comprising:
a first wheel configured to rotate about a first axis of rotation; and
a second wheel configured to rotate about a second axis of rotation, said second axis of rotation parallel to said first axis of rotation, wherein said flat portion of said surface area of said belt extends between said first wheel and said second wheel.

11. The currency transport assembly of claim 10 wherein said first wheel and said second wheel extend at least partially through said notch.

12. The currency transport assembly of claim 7 further comprising:
a currency cassette, wherein a transport path of the currency notes of the first plurality of currency notes is defined at least from a space between said first plate and said second plate to said currency cassette.

13. The currency transport assembly of claim 12 wherein said shuttle and said belt are configured such that the first plurality of currency notes is altered from the stacked arrangement to a shingled arrangement and is directed into said currency cassette in the shingled arrangement.

14. The currency transport assembly of claim 12 wherein the currency cassette further comprises:
a partition dividing an interior of said currency cassette into a first volume and a second volume and wherein the first plurality of currency notes is directed into only one of said first volume and said second volume.

15. The currency transport assembly of claim 14 wherein said first volume is smaller than said second volume and wherein the first plurality of currency notes is directed into only said first volume.

16. The currency transport assembly of claim 14 wherein the currency cassette further comprises:
a gate mounted on said partition for pivoting movement between a first position blocking said first volume and a second position blocking said second volume.

17. The currency transport assembly of claim 16 further comprising:
a second gate positioned along said path between said belt and said gate.

18. An automated transaction machine comprising:
a first currency cassette configured to hold a first plurality of currency notes;
a second currency cassette spaced from said first currency cassette and configured to separately hold reject notes and retract notes;
a currency transport assembly having:
a shuttle with a first plate defining a first surface and a second plate defining a second surface that confronts said first surface, wherein said second plate further comprising a notch and wherein said shuttle is moveable and a second plurality of currency notes is positionable in a stacked arrangement between said first plate and said second plate, and
a belt having a surface area including a flat portion that confronts said first surface and is at least partially positioned in said notch, said belt configured to rotate and direct notes of the second plurality of currency notes out of said shuttle;
a first gate positioned adjacent to said belt and moveable between at least a first position directing the notes of the second plurality of currency notes that are directed out of said shuttle to said first currency cassette and a second position directing the notes of the second plurality of currency notes that are directed out of said shuttle to said second currency cassette; and
wherein said shuttle and said belt are configured such that the second plurality of currency notes is altered from the stacked arrangement to a shingled arrangement when the second plurality of currency notes are directed out of said shuttle to said second currency cassette.

19. The automated transaction machine of claim 18 further comprising:
a second gate positioned within said second currency cassette for pivoting movement between a first position blocking a first volume within said second currency cassette and a second position blocking a second volume within said second currency cassette, said first gate positioned between said second gate and said belt along a transport path of the notes of the second plurality of currency notes.

20. The automated transaction machine of claim 19 wherein said first volume is smaller than said second volume.
